(19) United States
(12) Patent Application Publication
(10) Pub. No.: US 2007/0013547 A1
(43) Pub. Date: Jan. 18, 2007

(54) Automated meter reading system, communication and control network from automated meter reading, meter data collector, and associated methods

(76) Inventor: Jon A. Boaz, Colleyville, TX (US)

Correspondence Address: BRACEWELL & GIULIANI LLP, P.O. BOX 61389, HOUSTON, TX, 77208-1389, US

(21) Appl. No.: 11/439,531

(22) Filed: May 23, 2006

Related U.S. Application Data
(63) Continuation-in-part of application No. 10/779,429, filed on Feb. 13, 2004.
(60) Provisional application No. 60/447,815, filed on Feb. 14, 2003.

(51) Int. Cl. G08C 15/06

(52) U.S. Cl. 340/870.02

(57) ABSTRACT

An automated meter reading network system to collect utility usage data from multiple utility meters having utility meter sensors, program product, and associated methods are provided. The system includes multiple meter data collectors each in communication with one or more utility meters to collect utility usage data and forming a wireless communications network. The system also includes a host computer in communication with the meter data collectors either directly or through multiple field host data collectors which can be connected to the host computer through a wide area network. The system also includes a meter data collector program product at least partially stored in the memory of the host computer to manage the communication network. The meter data collector program product is adapted to analyze signal strength between nodes and to dynamically adjust the power level settings of the individual nodes to enhance network performance.

### RELATED APPLICATIONS

This application is a continuation-in-part of and claims priority to and the benefit of U.S. patent application Ser. No. 10/779,429 filed on Feb. 13, 2004, titled “Automated Meter Reading System, Communication and Control Network for Automated Meter Reading, Meter Data Collector, and Associated Methods,” which claims the benefit of U.S. Provisional Application Ser. No. 60/447,815, filed on Feb. 14, 2003, titled “Automated Meter Reading System, Communication and Control Network for Automated Meter Reading, Meter Data Collector, and Associated Methods,” both of which are incorporated herein by reference in their entireties.

### BACKGROUND OF THE INVENTION

1. Field of the Invention

The present invention relates in general to the field of utility meters. More particularly, the present invention relates to automatic equipment, systems, networks, and software for remote reading of utility meters.

2. Description of Related Art

Utility companies and municipalities for many years have been burdened with the labor intensive and cumbersome task of manually collecting meter readings, managing data from the field into the accounting area, and managing the billing and collection of invoices. Typically each customer is provided with a mechanical utility meter for each individual service provided, for example, a meter for water, a meter for steam, a meter for gas, and a meter for electric power. A periodic reading of the utility meter is necessary to determine the usage and to bill the customer for the amount used. These meters are normally manually read using utility company or municipality employees physically visiting each meter at the customer's location, reading the meter, and recording the previous month's usage into a written route book for delivery to accounting personnel. This process is costly, is time consuming, and can involve various risks to personnel involved in manually collecting meter data. The process involves labor, motorized transportation, and numerous employee overhead-related costs. Once the readings from the meter are obtained, accounting personnel manually transfer the readings into a database for billing and collection of the invoices for service.

Manually reading the meters often results in numerous other expenses including those related to human error. For example, a high bill caused by an incorrect manual read or estimated read often motivates customers to pay later, resulting in increased working capital requirements and corresponding expenses for the utility. Additionally, the utility has to handle the customer complaints (a call center cost) and may have to read the meter again to verify the error. As the complaint progresses, the utility faces administrative costs associated with routing and processing the complaint from the call center to the meter department. An additional cost includes the potential loss of a customer who, even after resolution, feels the process was such an excessive burden as to prompt the customer to switch utility providers.

Hand-held reading units have been developed that typically provide a data collection unit attached to the consumer's utility meter having some form of data transmitter. The unit or system has some form of receiver. There are different variations in methodology of receiving the data. One methodology of hand-held “local” collecting meter reading requires an operator having a meter or collection unit interrogation device to be in close physical proximity of the meter to obtain the meter reading and transport the data to a central computer such as shown in U.S. Pat. No. 5,559,894 by Lubliner et al. titled “Automated Meter Inspection and Reading” and U.S. Pat. No. 5,856,791 by Gray et al. titled “Port Expander For Utility Meter Reading.” For example, in a radio drive-by or walk-by unit, a utility service vehicle having a mobile receiver mounted in a service vehicle or a utility worker having a hand-held unit passes by the consumer's facility to receive the data from the meter. As the vehicle or hand-held unit passes near the electric meter, the receiver emits a signal to the collection unit, which causes the collection unit to transmit or send its meter reading data to the receiver. This consumption data is then stored and later entered into a billing system. This approach, however, still requires the manual visit to each meter location and time downloading the data to the billing system. Nevertheless, the physical meters can be read much more quickly which reduces manpower, vehicular, and soft costs. Also, the data is transferred from the mobile receiver to the database, which again reduces manpower and data handling. This methodology also has a benefit to the customer of preventing intrusion into the customer's premises and improved accuracy of the reading. Remaining system negatives, however, included prohibitive capital costs, i.e., vehicles, and software and hardware requirements, and providing a reliable and cost-effective power solution for the individual radio transmitter in the individual meters.

Automatic meter reading (“AMR”) has been developed. Automated meter reading has become more desirable than using meters that require manual reading and recording of the consumption levels. AMR consists of technologies and methods to remotely read a plurality of electric meters, such as a consumer base for an electric power supply company, into a billing database by installing or utilizing fixed networks that allow billing or meter usage data to be transmitted without human intervention to a host computer having the billing database. AMR produces many benefits and several companies such as Hunt Technologies, Schlumberger, CellNet, Itron, Amco Automated Systems, and Distribution Control Systems have developed AMR units. For the utility, reading meters without setting foot on customer's property substantially reduces risks associated with climbing over fences, slipping on ice and snow, dangerous animals, snakes, and spiders, and other types of risks which in turn, result in significant savings in liability insurance, disability benefits, and worker turnover/replacement. For the customer, reading meters without entering a customer's property provides a less intrusive service and reduces criminal activity such as when a criminal manages to gain entry into a customer's property by posing as a meter reader. Moreover, the need for a higher frequency of meter reading is increasing, e.g., daily, hourly, or every 15 minutes, in order to take advantage of real time pricing. Also, the amount of data is increasing, due to the necessity to bill on more than just consumption, e.g., time of use. Thus, automated recording and reporting of the utility usage at customer sites is rapidly replacing the manually read utility meters.

AMR systems can use a dial-up modem in the collection unit to dial a remote billing system and transmit its reading data via telephone lines such as that shown in U.S. Pat. No. 6,163,602 by Hammond et al. titled “System and Method for Unified Telephone and Utility Consumption Metering, Reading, and Processing” and U.S. Pat. No. 5,128,988 by Cowell et al. titled “Telephone Switched Network, Automatic Meter-Reading System Based Upon Service Address.” In the past, there have been on-site meter reading equipment having a modem capable of receiving telephone calls from a central office through the use of special equipment located at the telephone company, and there have also been on-site meters with modems which were capable of placing telephone calls to the central office. In general, these systems incorporate an auto-dial, auto-answer modem in each customer site to receive interrogation signals from the telephone line and to formulate and transmit meter readings via the telephone line to the utility company. These systems record information on utility usage and periodically dial into a central office to report the utility usage for recording and billing purposes. This methodology provides two-way communication and control between the meter and the central office. The modem shares the telephone line with the customer's normal usage, such as incoming and outgoing voice communications. Such sharing requires that the system be able to recognize when the telephone line is in use, and to delay demanding use of the telephone line until it is free. Steps must be taken to prevent the data communications system from interfering with other uses and to prevent other uses from corrupting the transmitted data.

A variation of this methodology includes using the power line as a carrier medium. This approach connects the meter through the power lines and relays the meter reading over the power lines to the utility company. This approach, however, can require a complicated infrastructure to be installed. Power lines operate as very large antennas and can receive a large amount of noise. Therefore, signal-cleaning filters must be installed periodically along the power lines to attenuate the noise. These filters can be very expensive. Also, the connections often are at line voltage, making it more dangerous and time consuming to install.

Another problem with expanding the use of control systems technology to such distributed systems are the costs associated with the sensor-actuator infrastructure required to monitor and control functions within such systems. A more modern approach to implementing control system technology is to install a local network of hard-wired sensors and actuators along with a local controller. Not only is there the expense associated with developing and installing appropriate sensors and actuators, but there is the added expense of connecting functional sensors and controllers with the local controller and the cost of the local controller. This methodology is also quite intrusive as the cables must be run to physically interconnect the various nodes in the network. An alternative variation includes interfacing the meter with a community cable television system. In addition to the high cost of installation, however, such a system is not useable in areas without access to a cable system. Moreover, networks that are interconnected with cables are subject to physical disruption of the cables.

Wireless networks have been developed. These networks are used to collect information from and to disseminate information to individual nodes of the network. These networks, including those that employ frequency hopping, are typically installed in a point-to-point loop configuration. In wireless networks using a point-to-point loop configuration, each node in the network is interconnected and communicates with two neighboring nodes. Information or commands are passed from node to node around the point-to-point loop until they arrive at a master node. The master node is used to communicate information that is gathered to a central station or to accept and distribute throughout the network information received from a central station. In a network employing frequency hopping, the master node can distribute instructions that control the frequency hopping. These wireless networks, however, have limitations. For example, because these wireless networks generally have a point-to-point loop configuration, when one node is disabled, the integrity of the entire network can be affected. Moreover, if the master node of such a network is disabled, the network can become isolated. Further, such master-slave relationship results in a significant increase in processing overhead in the node controller or CPU. Other variations in methodology include using data channels in wireless telephone systems to transmit usage data to a remote billing system via a wireless telephone network, such as PCS, satellite, or cellular. Other methodologies also include the use of low earth orbiting satellites. Building, launching and maintaining a fleet of satellites, however, is very expensive.

Yet another methodology includes the use of small low-power radiofrequency (“RF”) transmitters. Such RF transmitters have their transmission power predetermined and set during installation, normally at a maximum value due to the limited range of such low-power RF transmitters. In order to deploy such systems, a study is typically conducted to determine positioning of a RF master or repeater antenna tower or towers. In order to perform the study, signal strengths are typically measured at various locations to determine the range from the antennas. Receiver sensitivity at each node is then measured to verify acceptable positioning. A fixed maximum radius from the antenna towers is then assigned to the RF system. Recognized by the Applicant is that if the power is not initially set correctly, the RF transmitter will not function properly within the network configuration. Further, recognized by the Applicant is that the environment with which the RF transmitters are positioned may change over time such that the RF transmitter at the predetermined power setting will be rendered ineffective. For example, walls or fences can be constructed adjacent the transmitter, trees can form new leaves or lose existing ones due to change of the seasons, or equipment that emits RF signals over an overlapping or adjacent frequency band can be installed. Additionally, recognized by the Applicant is that networks using such low-power RF transmitters may lose utility usage data due to typically temporary interruptions in the transmission of such usage data when such data is being relayed between multiple low-power RF transmitters.

In an attempt to address the metering data management needs of entities involved in energy distribution, automated meter reading servers have been developed, such as shown in U.S. Pat. No. 6,088,659 by Kelley et al. titled “Automated Meter Reading System.” Such automated meter reading servers use an open, distributed architecture that collects, loads, and manages system-wide data collected from energy meters, and routes data automatically to upstream business systems. Although such automated meter reading servers may address some meter data management concerns, these systems still fail to address communication concerns set forth above with respect to collecting billing or usage data and transmitting the data to a control center having such an automated meter reading server.

The Applicant has recognized a need to automate and transform the process of metering electricity, gas, water, steam, and the like, while reducing costs, adding value, enhancing service, and decreasing time of collection. Applicant has recognized a need for a robust network automated meter reading solutions that includes a multifunction meter data collector capable of transmitting meter readings for multiple utility meters to a control center and capable of relaying meter readings of other collectors. Accordingly, Applicant has also recognized a need for control systems technology to control such distributed systems that provides the ability to monitor received signal strengths between meter data collectors, automatically adjust transmission power levels to compensate for environmental changes, and detect transitory loss of usage data between meter data collectors, and recover such data.

### SUMMARY OF THE INVENTION

In view of the foregoing, embodiments of the present invention advantageously provide an automated utility meter reading network system, program product, and methods related to an automated data acquisition and energy management. Embodiments of the present invention provide an automated meter reading network system to automate and transform the process of metering electricity, gas, water, steam, and the like, while reducing costs, adding value, enhancing service, and decreasing time of collection. Embodiments of the present invention advantageously provide a distributed network system to collect and analyze utility usage data that includes sensors interfaced with or connected to utility meters, which provide the ability to take automated utility meter readings, and a remote automated meter reading control center including a host computer, e.g., a server, for gathering and processing the utility usage data. Embodiments of the present invention provide a robust system that, through a refresh process, can continuously analyze individual segments of the mesh network in order to ensure availability of the maximum number of segments. Embodiments of the present invention also provide an automated meter reading network system that supports bi-directional communications with a network of meter data collectors capable of automated reconfiguration of the network structure and automated adjustment of transmission power level settings due to environmental factors.

More specifically, an embodiment of the present invention provides an automated meter reading network system including at least one but preferably a plurality of utility meters, e.g., water, gas, steam, electric, and/or other, some located at the same customer site, others located at separate customer sites. A plurality of sensors are correspondingly each interfaced with and positioned adjacent a separate one of the plurality of utility meters to thereby sense utility usage data from each of the plurality of utility meters. A plurality of meter data collectors are each preferably positioned, for example, within one of the utility meters and/or adjacent one or more of the utility meters, and in communication with one or more of the sensors to collect the utility usage data. Each meter data collector can be configured to collect data from up to 20 or more metering inputs and can provide a digital output board for device control. An analog input module can also be provided to allow for monitoring of customer equipment, providing municipalities the ability to create additional revenue sources. For example, if equipped with the analog input module, each meter data collector can monitor air-conditioning performance points, such as pressure and temperature. All metering data can be date and time stamped, providing an accurate record of the exact day and time the customer's meters are read.

Each of the meter data collectors can include a radio frequency telemetry module to transmit the utility usage data. Correspondingly, each meter data collector can be positioned spaced apart from and in cross-radio frequency communication with at least one other meter data collector to define and form a mesh communication network. The meter data collectors can act as a repeater as well as a collection unit creating a communications network with self-healing and self-determining characteristics. Advantageously, this network configuration creates its own infrastructure as additional meter data collectors are added to the mesh communications network. Further, advantageously the mesh network configuration can be divided into a plurality of radially expanding network levels whereby meter data collectors at a first network level would communicate with meter data collectors at a second network level, and so on, through each network level.

The automated meter reading network system can also include a plurality of field host data collectors, each positioned spaced apart from the other ones of the plurality of field host data collectors and each in radio frequency communication with at least one but preferably a plurality of the meter data collectors, to request and collect utility usage data from the plurality of meter data collectors. The combination of field host data collectors and the meter data collectors further define and form the mesh communication network. As such, each of the field host data collectors and the meter data collectors form an array of communication nodes having overlapping and interconnected coverage areas. This network configuration helps reduce line-of-site communication problems between each of the nodes beyond what would be possible if the mesh communications network were entirely wireless. The field host data collectors can reside at the municipality infrastructure level, such as at a substation, pump station, or municipal office, and can connect the mesh communications network to a wireless, cable, fiber or telephony WAN. Advantageously, each of the field host data collectors can be used as routers and repeaters, eliminating a requirement for an expensive infrastructure build-out. Advantageously, this configuration also allows for data transfer over varying types of network configurations between a host computer and the field host data collectors, including over the pre-existing public telephone networks. The field host data collectors have or can have access to memory to store and process the collected utility usage data.

The host computer is generally located remote from the field host data collectors and most of the meter data collectors and is positioned in communication with each of the field host data collectors and each of the meter data collectors to provide instructions thereto and to receive data. The host computer is also in communication with the field host data collectors to request and receive the utility usage data. Advantageously, the host computer can analyze the utility meter or usage data to provide services, such as, for example, utility usage analysis, utility bill presentation via the Internet, historical utility data, utility leak detection, power outage detection, and current near real-time utility readings and usage. Providing the customer such near real-time feedback on current energy usage and near real-time utility meter-read verification can advantageously lessen billing disputes and reduce customer service overhead costs. Advantageously, the host computer can also provide appliance control and community-wide message delivery.

The automated meter reading network system also includes a meter data collector program product at least partially stored in the memory of the host computer that includes a set of instructions adapted to manage the mesh communication network. The meter data collector program product is capable of querying each meter data collector and assigning the meter data collector a physical location based on the actual physical location with reference to other collectors or “nodes.” The meter data collector program product includes instructions that when executed by a computer (processor or controller), can perform the operation of determining an outbound sequence route from a host computer system to a destination meter data collector typically through one or more gateway meter data collectors, and an inbound sequence route from the destination meter data collector. The instructions can also include those executable to perform the operations of assigning a transmission power level setting separately to each of the meter data collectors along the outbound and the inbound sequence routes, assembling a message packet to include the power level settings for transmitting the message packet and to include placeholders for retrieving a received signal strength indication between adjacent meter data collectors describing the received signal strength of the message packet received from an adjacent meter data collector or collectors along the outbound and the inbound routes, and sending or otherwise forwarding the message packet along the outbound sequence route.

The instructions associated with the individual collectors along the outbound and inbound sequence routes can include those to perform the operations of determining and recording a received signal strength indication describing the received signal strength of a transmission between the adjacent transmitting meter data collectors, and adding, copying, or otherwise uploading the received signal strength indication to the message packet. These instructions can also include those to perform the operations of reading the received power level and transmission frequency, setting the transmission power level and frequency, and forwarding or otherwise sending the message packet along the preselected route. Correspondingly, the instructions associated with the host computer system can include those to perform the operations of receiving the message packet, validating the message packet, and analyzing the received signal strength indications for one or more of the meter data collector.

The operations of determining outbound and inbound sequence routes, assigning power level settings, assembling a message packet, sending the message packet, receiving the message packet, validating the message packet, and analyzing received signal strength indications can be iteratively performed using a different power level setting for at least one of the meter data collectors along either the outbound or inbound routes so that a common segment can be “refreshed” and analyzed to determine the optimum power level setting for transmitting over that common segment. As such, the instructions can include those to perform the operations of processing the received data from the validated message packets in response to the validation, comparing the received signal strength indication of one or more common segments, and determining an optimal transmission power level setting of at least one of the nodes in response to the data analysis.

According to an embodiment of the meter data collector program product, the program product includes various functional modules such as, for example, a protocol message packet generator, a protocol message packet validator, a received signal strength indication determiner, and a power level settings determiner. The protocol message packet generator is adapted to assemble a protocol message packet including routing instructions between a plurality of meter data collectors, power level settings assignments for the meter data collectors, and received signal strength indication placeholders to receive from each of the meter data collectors signal strength indications indicating the received signal strength of the protocol message packet. The protocol message packet validator is adapted to perform a validation analysis on a routed version of the protocol message packet to determine if the protocol message packet contains corrupted data. The received signal strength indication determiner is adapted to extract the receive signal strength indication from the protocol message packet responsive to protocol message packet validation. The power level settings determiner is adapted to determine a substantially optimum power level setting for each of the meter data collectors responsive to the extracted received signal strength indications to thereby enhance individual mesh network segment strength and improve overall network performance.

Embodiments of the present invention also advantageously provide methods of collecting utility meter usage data from a plurality of utility meters having utility meter sensors in communication with a plurality of meter data collectors (nodes) forming a mesh network. For example, a method, according to an embodiment of the present invention, includes determining an outbound or first sequence route from a source node to a destination node through preferably at least one gateway node, and an inbound or second sequence route from the destination node to the source node. The method also includes assigning a transmission power level setting separately to each of the nodes along the outbound and the inbound sequence routes, assembling a message packet to transmit data from a host computer system to the selected destination node according to the outbound sequence route, and transmitting the message packet to the destination node along the outbound sequence route. The data transmitted with the message packet can include the power level settings for each of the nodes and placeholders for retrieving a received signal strength indication between adjacent nodes along the routes indicating the strength of the received signal associated with the transmission of the message packet at the assigned power level settings. Upon receipt of the message packet, each node along the outbound sequence route can determine and record a received signal strength indication describing the received signal strength of a transmission between the adjacent nodes, add, copy, or otherwise upload the received signal strength indication to the message packet, and transmit the message packet to the next node according to the outbound and inbound routes. The method can also include receiving and validating the message packet and analyzing data in the message packet transmitted to the host computer system.

The above described steps can be iteratively performed using different power level settings on one or more of the nodes in order to perform a comparative data analysis of received signal strengths with respect to the various power level settings. In response to the data analysis, an optimal transmission power level setting of the one or more of the nodes can be readily determined. Additionally, a communication sequence to each of the nodes can be determined responsive to the determined received signal strength of the communication signal between each adjacent node pair to define a preferred communication sequence path to each of the nodes from the host computer.

Another embodiment of a method of collecting utility meter usage data can include determining a first sequence route from a source node to a destination node through, for example, at least one gateway node, and a second sequence route from the destination node to the source node. The method can include assigning a transmission power level setting separately to each of the nodes along the first and the second sequence routes, transmitting at least one message packet carrying the power level settings along the first sequence route, and determining a first message packet data return rate. The method can also include determining a third sequence route having at least one common segment with the first sequence route or the second sequence route, varying a transmit power level setting of at least one of the nodes associated with the common segment, transmitting a second message packet carrying the varied power level setting along the third sequence route, and determining a second message packet data return rate. The method can further include comparing the first message packet data return rate to the second message packet data return rate, and selecting the second power level setting or settings for the at least one of the nodes responsive to the comparison when the second message packet data return rate is greater than the first message packet data return rate.

According to an embodiment of the present invention, a method of collecting utility meter usage data can include providing remote firmware management of the meter data collectors. The method can include determining a sequence route from a host computer system to a destination meter data collector generally through one or more intermediate meter data collectors and transmitting a message packet to the destination meter data collector along the sequence route. The method also can include receiving and storing the firmware update in memory of each intermediate “destination” meter data collector prior to forwarding the message packet to the destination meter data collector. Advantageously, if the firmware update is to be made to each meter data collector in the mesh network or a significant portion thereof, such step can significantly reduce the number of message packet transmissions. The method also includes receiving and storing the firmware update in memory of the final destination meter data collector, and can further include delaying implementing the firmware update to allow a synchronized update of the firmware for each of the destination meter data collectors.

According to an embodiment of the present invention, a method of collecting utility meter usage data can include providing remote memory management of the meter data collectors. The method can include determining a sequence route from a host computer system to a destination meter data collector generally through one or more intermediate meter data collectors and transmitting a message packet containing a payload data element including a meter data collector memory management instructions/parameters to the destination meter data collector along the sequence route. The method also can include receiving and processing the memory management instructions/parameters and transferring data between the various volatile and nonvolatile memory elements of the destination meter data collector according to the instructions/parameters.

According to an embodiment of the present invention, a method of collecting utility meter usage data is provided which can enhance history and usage data integrity for data remotely retrieved from a plurality of meter data collectors by preventing history and usage data loss resulting from post transmission message packet loss or corruption of a message packet carrying history and usage data. Such a method can include determining a sequence route from a computer system to a selected destination meter data collector, for example, through one or more intermediate meter data collectors, and assembling or otherwise providing a message packet having a payload data element adapted to carry a history and usage pointer which provides indicia of a starting point in memory of the selected meter data collector of unread (unsent) history and usage data. The method can also include accessing a database to determine the next-read memory location for the selected meter data collector, loading the next-read memory location into the payload data element of the message packet, and transmitting the message packet to the selected destination meter data collector along the sequence route. The method can further include receiving the message packet by the selected meter data collector, accessing the history and usage pointer provided in the payload data element, and reading a block of history and usage data from the memory of the meter data collector in response to the history and usage pointer.

Accordingly, the method can also include loading the read history and usage data and loading indicia of a next-read memory location indicating the next position in the memory of the meter data collector to retrieve history and usage data in the payload data element for transmission to the host computer, transmitting the read history and usage data to the host computer, receiving and otherwise extracting the read history and usage data from the payload data element of the message packet, and storing the history and usage data and the indicia of the next-read memory location in the database. Advantageously, this next-read memory location can be used in the next iteration of requesting history and usage data from the respective meter data collector.

Embodiments of the present invention also advantageously provide a computer readable medium that is readable by a computer (processor) collecting utility meter usage data. For example, a computer readable medium according to an embodiment of the present invention can include a set of instructions that, when executed by the computer, cause the computer to perform the operation of determining an outbound sequence route from a host computer system to a destination meter data collector typically through one or more intermediate gateway meter data collectors and an inbound sequence route from the destination meter data collector. The instructions can also include those to perform the operations of assigning a transmission power level setting separately to each of the meter data collectors along the outbound and the inbound sequence routes, assembling a message packet to include the power level settings for transmitting the message packet and to include placeholders for retrieving a received signal strength indication between adjacent meter data collectors describing the received signal strength of the message packet received from an adjacent meter data collector or collectors along the outbound and the inbound routes, and sending the message packet along the outbound sequence route. The instructions can also include those to perform the operations of receiving the message packet, validating the message packet, and analyzing the received signal strength indications for one or more of the meter data collector. Advantageously, polling multiple meter data collectors in a single message packet transmission can provide a significant reduction in network congestion over that of performing separate single-level polling of individual segments.

The instructions associated with the individual collectors can include those to perform the operations of determining and recording a received signal strength indication describing the received signal strength of a transmission between the adjacent transmitting meter data collectors, uploading the received signal strength indication to the message packet, reading the received power level and transmission frequency, setting the transmission power level and frequency, and forwarding or otherwise sending the message packet along the preselected route or routes.

The operations of determining outbound and inbound sequence routes, assigning power level settings, assembling a message packet, sending the message packet, receiving the message packet, validating the message packet, and analyzing received signal strength indications can be iteratively performed using a different power level setting for one or more of the meter data collectors along either the outbound or inbound routes so that a common segment can be “refreshed” and analyzed to determine the optimum power level setting for transmitting over that common segment. As such, the instructions can include those to perform the operations of processing the received data from the validated message packets in response to the validation, comparing the received signal strength indication of one or more common segments, and determining an optimal transmission power level setting of at least one of the nodes in response to the data analysis.

According to an embodiment of the present invention, a power level setting can be considered an improvement when transmission of the message packet at a particular transmission power level setting improves the message packet validation rate of a message packet or packets transmitted along the common segment, or at least does not substantially reduce the message packet validation rate of the message packet or packets transmitted along the common segment and the second transmission power level setting is less than that of the previous iteration or iterations. As such, the instructions can also include those to perform the operation of determining a first sequence route from a source node to a destination node through at least one gateway node and a second sequence route from the destination node to the source node, assigning a transmission power level setting separately to each of the nodes along the first and the second sequence routes, sending at least one message packet carrying the power level settings along the first sequence route, and determining a first message packet data return rate. The instructions can also include those to perform the operations of determining a third sequence route having at least one common segment with the first sequence route or the second sequence route, varying a transmit power level setting of at least one of the nodes associated with the common segment, sending a second message packet carrying the varied power level setting along the third sequence route, and determining a second message packet data return rate. Additional such iterations can also be performed. The instructions can further include those to perform the operations of comparing the first message packet data return rate to the second message packet data return rate and selecting the second power level setting for the at least one of the nodes responsive to the comparison when the second message packet data return rate is greater than the first message packet data return rate or when the second message packet data return rate is not substantially less than the first message packet data return rate and the second power level setting of the at least one of the nodes is less than the first power level setting.

According to an embodiment of the present invention, collecting utility meter usage data also includes efficient firmware management. As such, a computer readable medium includes a set of instructions that, when executed by a computer (processor), cause the computer to perform the operations of determining a sequence route from a host computer system to a destination meter data collector through, for example, one or more intermediate meter data collectors, assembling a message packet having a payload data element for carrying a meter data collector firmware update, and sending the message packet along with the firmware update to the destination meter data collector along the sequence route. Accordingly, the instructions, particularly those associated with the meter data collectors, can include those to perform the operations of receiving and storing the firmware update in memory of each intermediate meter data collector prior to forwarding the message packet to the final destination meter data collector, and receiving and storing the firmware update in memory of the final destination meter data collector.

Collecting utility meter usage data can also include efficient memory management. According to an embodiment of the present invention, a computer readable medium can include a set of instructions that, when executed by the computer (processor), cause the computer to perform the operations of determining a sequence route from a host computer system to a destination meter data collector, assembling a message packet having a payload data element for carrying meter data collector memory management parameters, and sending the message packet along with the memory management parameters to the destination meter data collector along the sequence route. The instructions, particularly those associated with the meter data collectors, can further include those to perform the operation of receiving the memory management parameters and transferring data between the volatile and nonvolatile memory elements of the destination meter data collector in response the memory management parameters.

According to embodiments of the present invention, part of collecting utility meter usage data includes history and usage data integrity. According to an embodiment of the present invention, a computer readable medium includes a set of instructions that, when executed by a computer, cause the computer to perform the operations of determining a sequence route from a host computer system to a destination meter data collector, providing a message packet having a payload data element, accessing a database to determine the next-read memory location for the selected meter data collector, loading a history and usage pointer in the payload data element, and sending the message packet to the destination meter data collector along the sequence route. Advantageously, the history and usage pointer provides indicia of a starting point in memory of the destination meter data collector of the next block of unread history and usage data defining the next-read memory location.

The instructions, particularly those associated with the meter data collectors, can include those to perform the operations of sensing meter usage data from one or more utility meters, collecting and storing the history and usage data in memory, receiving the message packet, accessing the history and usage pointer provided in the payload data element, reading a block of history and usage data from the memory of the meter data collector responsive to the history and usage pointer, loading the read history and usage data in the payload data element for transmission to the host computer system, loading indicia of a next read-memory location in the payload data element for transmission to the host computer system, and sending or otherwise forwarding the message packet to the host computer system. Advantageously, the indicia of a next read-memory location can indicate the position in the memory of the destination meter data collector to retrieve the next block of history and usage data during the next history and usage data retrieval iteration.

Accordingly, particularly those instructions associated with the host computer system, can include those executable to perform the operations of receiving the read history and usage data and next-read memory location indicia and storing the history and usage data and next-read memory location indicia in the database for later retrieval for use with retrieving the next block of history and usage data not received by the host computer system. Advantageously, such indicia can be used to prevent data integrity failure due to, for example, in route loss or corruption of the history and usage data during transit between the meter data collector or collectors and the host computer system.

Embodiments of the present intention also advantageously can include a computer memory element containing, stored in signal bearing media, a database containing in computer readable format data indicating utility service history and usage provided by each of a plurality of meter data collectors and data indicating for each of the plurality of meter data collectors a starting point in memory of the next block of unread history and usage data defining a next-read memory location.

Advantageously, embodiments of the present invention also provide an automated meter reading network system that supports bi-directional communications with a network of meter data collectors capable of collecting digital and analog input data, as well as providing functional control of various customer equipment via a digital output board or relay. Embodiments of the present invention offer an intelligent, low-cost, wireless automated meter reading solution that supports the ability to obtain more easily (instantly) final meter reads for opening/closing accounts, and help in pinpointing and preventing system losses. Advantageously, the meter data collectors can be located at a customer location, such as, for example, mounted to a residence or other building structure within one of the utility meters, e.g., the electric utility meter, and can each be connected to all utility meters at a respective customer location. The meter data collectors can monitor utility usage data through multiple digital or analog inputs and/or multiple encoded inputs, and can transmit that data to a host computer, preferably located at a utility's central office, via a preferably 902-928 mega-hertz and/or 2.4-5.8 gigahertz fixed frequency or frequency hopping mesh network. The meter data collectors can utilize a medium to high range radio frequency (RF) transceiver capable of communications of 1600 meters or approximately one mile with field host data collectors that connect the network to a wireless, cable, fiber, or telephony wide area network. The field host data collectors can reside at a municipality infrastructure level, such as a substation, pump station, or municipal office. Intelligent field host data collectors can function as a host computer, collecting utility usage data from the surrounding meter data collectors, intermediate collectors, and/or other field host data collectors, and can transmit that utility usage data either when requested by the host computer or periodically at a predetermined interval.

### BRIEF DESCRIPTION OF THE DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a schematic block diagram of an automated meter reading network system according to an embodiment of the present invention;

FIG. 2 is schematic diagram of an automated meter reading network system according to an embodiment of the present invention;

FIG. 3 is a schematic diagram of an automated meter reading network system according to an embodiment of the present invention;

FIG. 4 is a schematic diagram of an automated meter reading network system according to an embodiment of the present invention;

FIG. 5 is a schematic diagram of an automated meter reading network system according to an embodiment of the present invention;

FIG. 6 is an environmental view of a plurality of meter data collectors each positioned on a separate building and in communication with a main utility center according to an embodiment of the present invention;

FIG. 7 is an environmental view of a plurality of meter data collectors each positioned on a separate building and in communication with a utility control center according to an embodiment of the present invention;

FIG. 8 is an environmental view of a plurality of meter data collectors each positioned on a separate building and in communication with a water tower having a meter data collector or repeater mounted thereto and in communication with a utility control center according to an embodiment of the present invention;

FIG. 9 is schematic block diagram of a meter data collector and having a plurality of data collection ports each for a plurality of different utility meters or other uses according to an embodiment of the present invention;

FIG. 10 is an exploded perspective view of a meter data collector associated with an embodiment of a housing according to an embodiment of the present invention;

FIG. 11 is an exploded perspective view of a meter data collector associated with an embodiment of a housing according to an embodiment of the present invention;

FIG. 12 is a schematic block diagram of program product to collect utility meter usage data according to an embodiment of the present invention;

FIG. 13 is a schematic diagram of message packet travel route along a plurality of nodes of an automated meter reading network system according to an embodiment of the present invention;

FIG. 14 is a schematic diagram illustrating message packet construction along each of the plurality of nodes of FIG. 13 according to an embodiment of the present invention;

FIG. 15 is a schematic diagram of message packet travel route along a plurality of nodes of an automated meter reading network system according to an embodiment of the present invention;

FIG. 16 is a schematic diagram of message packet travel route along a plurality of nodes of an automated meter reading network system according to an embodiment of the present invention;

FIGS. 17A-F is a schematic block diagram of a radio frequency receiving vector interrupt service routine for meter data collectors and wireless capable host computer systems according to an embodiment of the present invention;

FIGS. 18A-C is a schematic flow diagram of a method of collecting utility meter usage data according to an embodiment of the present invention;

FIG. 19 is a schematic flow diagram of a method of collecting utility meter usage data according to an embodiment of the present invention;

FIG. 20 is a schematic flow diagram of a method of collecting utility meter usage data according to an embodiment of the present invention; and

FIG. 21 is a schematic flow diagram of a method of collecting utility meter usage data according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. The prime notation, if used, indicates similar elements in alternative embodiments.

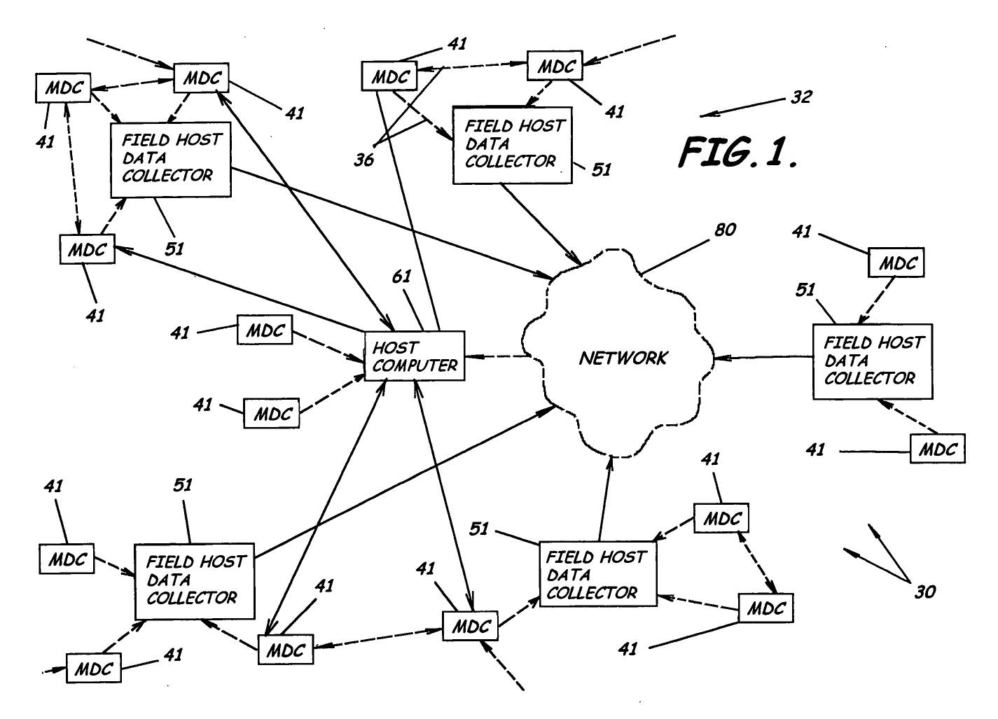

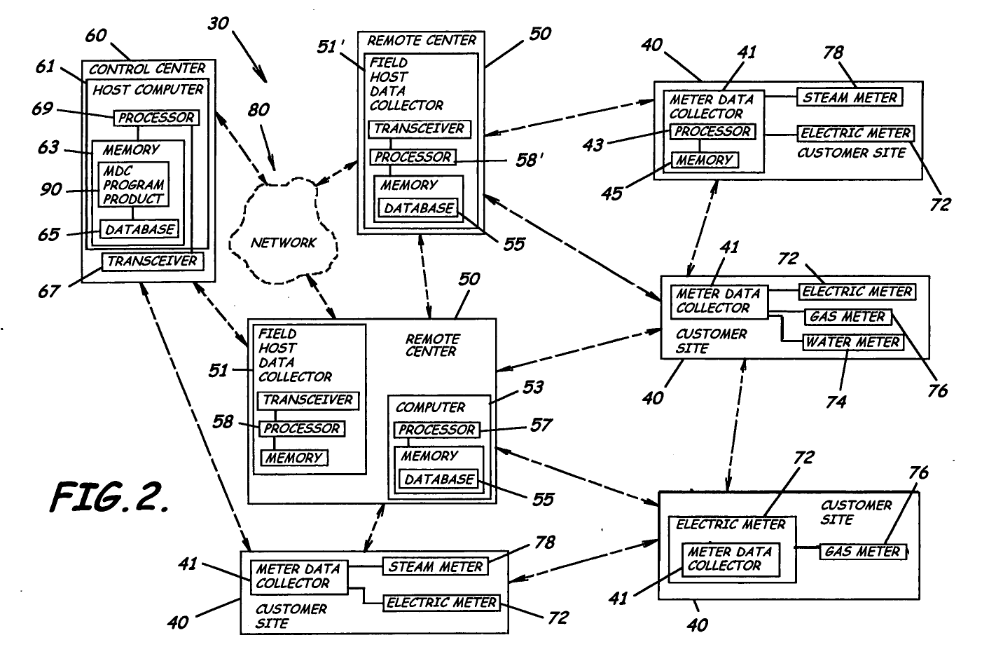

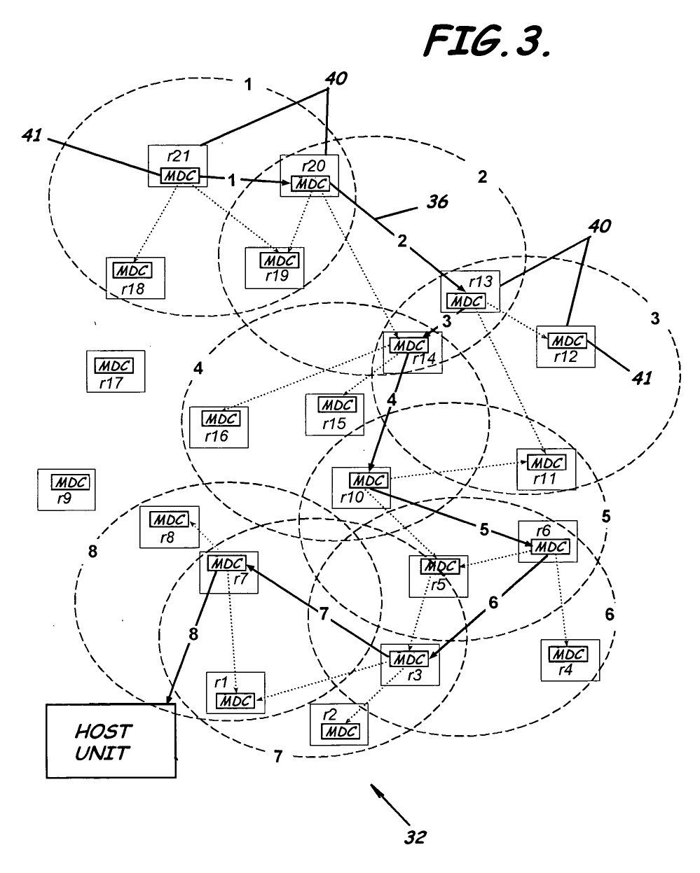

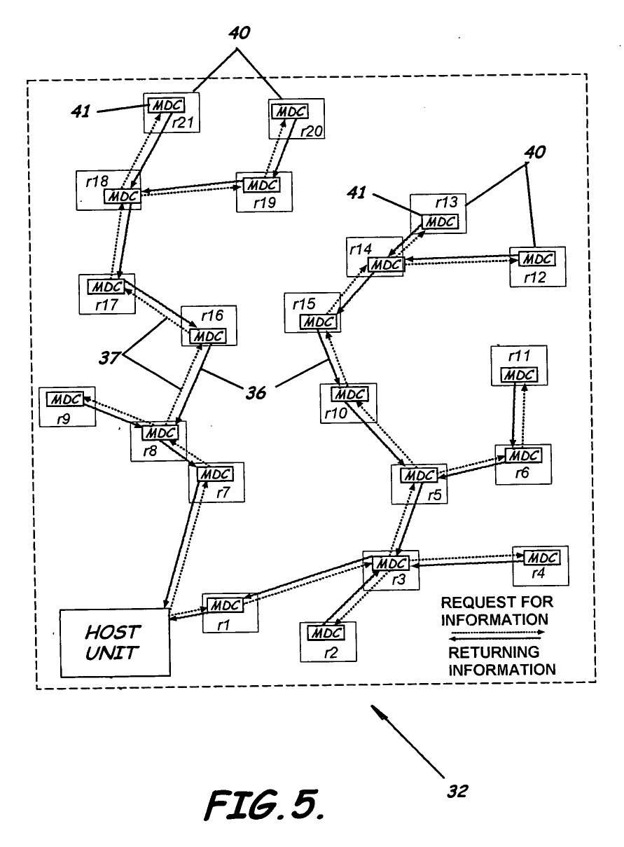

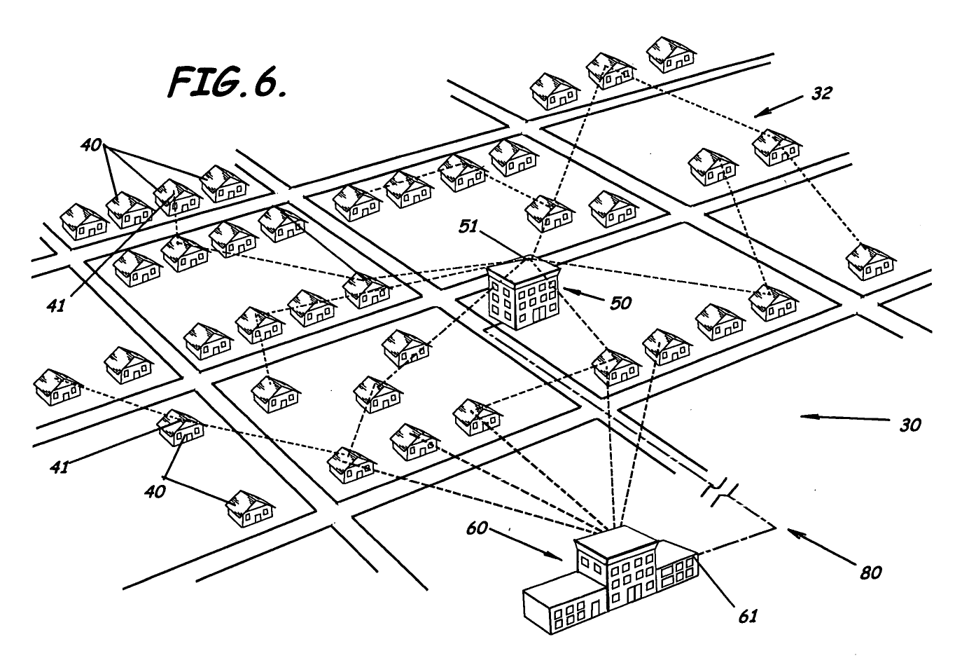

As illustrated in FIGS. 1-21, embodiments of the present invention incorporate an automated meter reading network system 30 including a multifunction meter data collector 41, a utility meter e.g., electric 72, water 74, gas 76, steam 78, or other usage, and an at least one sensor 73, 75, 77, 79, e.g., an encoder or other sensor element known to those skilled in the art, interfaced with the meter, that advantageously provides for both automated data acquisition and energy management. The sensor or sensors are positioned in electrical communication with the meter data collector 41 in order to provide a meter usage reading data. The system 30 also includes a control center 60 for gathering and processing the usage reading data. The system 30 also includes system software or program product. Preferably, the network software or program product includes a network protocol (preferably an application layer protocol, described later) for communicating over a network e.g. mesh network 32 (FIGS. 1 and 6) connected to each of a plurality of meter data collectors 41 which can form nodes within the network. Generally, the automated meter reading network system 30 can support bi-directional communications with a network of meter data collectors 41 with the capability of collecting digital and analog input data, as well as functional control via a digital output board or relay. In an embodiment of a system 30, such as perhaps best shown in FIG. 5, the system 30 can use frequency hopping radio frequency (“RF”) electromagnetic radiation as understood by those skilled in the art. Use of an RF based network, for example, can reduce data transmission cost, is flexible, and has low deployment costs.

As shown in FIGS. 1, 2, and 9, according to an embodiment of the present invention, an automated meter reading network system 30 includes a plurality of utility meters, e.g., electric 72, water 74, gas 76, steam 78, and/or other usage, generally distributed either at a very large customer site or throughout a plurality of smaller customer sites 40. Each of the utility meters is preferably interfaced with and positioned adjacent one or more usage sensors, e.g., sensors 73, 75, 77, 79, which sense utility usage data from the respective utility meters. A plurality of multifunction meter data controllers or collectors 41 are each positioned, for example, adjacent or within one or more of the utility meters and are in communication with the respective utility meters through the respective utility usage sensors to collect the utility usage data from each of the sensors. The meter data collectors 41 can be located at a customer location, such as, for example, mounted to a residence or other building structure 40, and can each be connected to all utility meters at the customer's location. The meter data collectors 41 can monitor utility usage data through, for example, multiple digital or analog inputs and/or multiple encoded inputs, and can transmit that data to a host computer 61, preferably located at a utility's central office 60, via a preferably 902-928 mega-hertz and/or 2.4-5.8 gigahertz frequency hopping mesh network 32. Each meter data collector 41 can include provisions for collecting up to 20 or more utility usage inputs and can be provided with a digital output board or relay 48 to provide for external device control. Each meter data collector 41 preferably includes a radio frequency telemetry module 44 or other wireless communication means, known to those skilled in the art, to transmit the utility usage data.

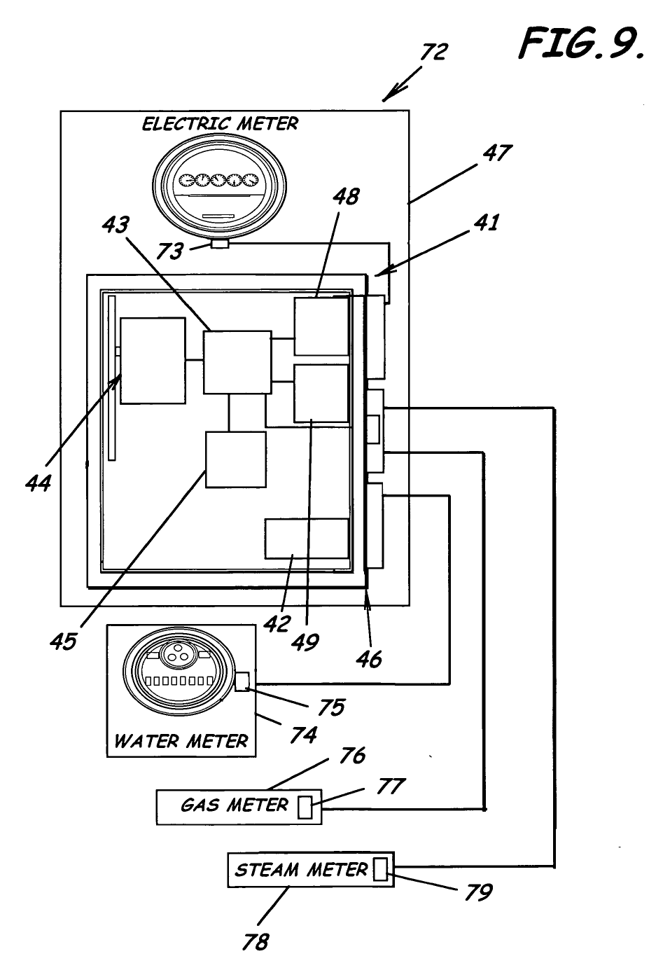

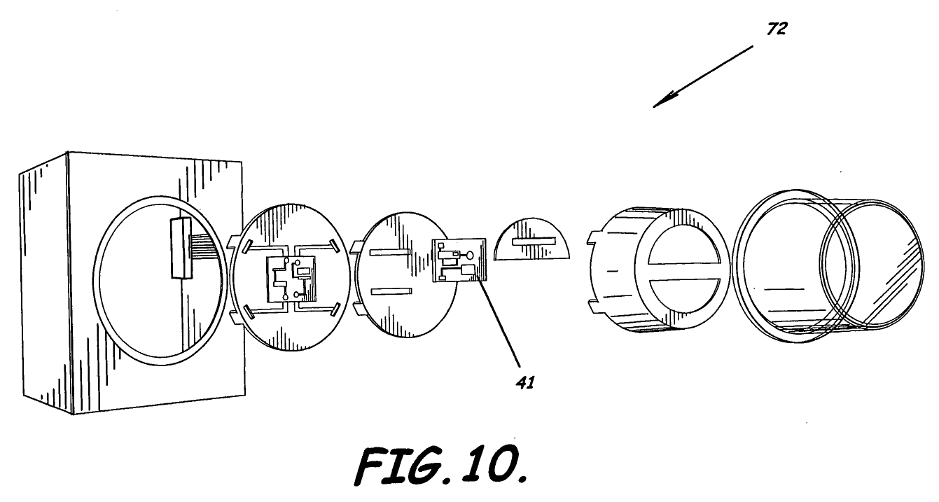

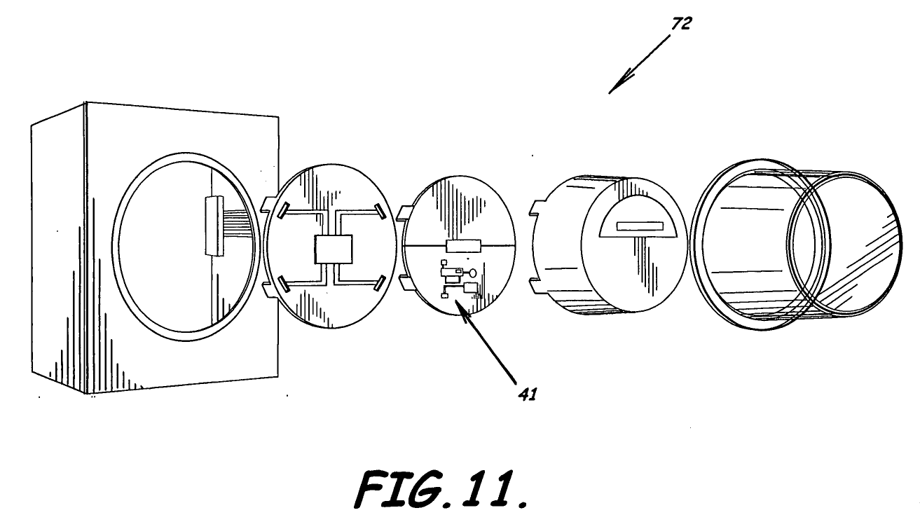

As shown in FIG. 9, each meter data collector 41 includes a power module 42, a microcontroller 43, a telemetry module 44, a memory module 45, a multiple input connection block 46 including digital and analog inputs, and a housing preferably meeting NEMA standards to enclose the multifunction collector 41. The housing can be that of the electric utility meter 72 as shown in FIGS. 10 and 11, or an externally mounted stand-alone housing (not shown). The power module 42 for each meter data collector 41 can receive electric power from either an associated electric utility meter 72 or a separate plug-in power supply. The microcontroller 43 can function to receive sensor data indicating utility usage, store the utility usage data, determine a received signal strength of a received signal, receive a power level setting and frequency to be used in transmitting data, and set the power level and the frequency in the telemetry module 44. The utility usage data obtained by the meter data collector 41 from the meter sensor can be temporarily stored in either volatile memory, e.g., microcontroller flash memory, or non-volatile memory, e.g., ferroelectric random access memory, collectively memory 45. The utility usage data can be date and time stamped to provide an accurate record of the read. Typically and functionally, this data is then forwarded directly to the remote control center 60 or a substation 50 if within range and not blocked or impeded by a physical structure or other obstacles.

As identified above, the telemetry module 44 can be calibrated to transmit and receive on a selected discrete frequency at a selected discrete power level. The telemetry module 44, as known to those skilled in the art, can include a pre-amplification portion and power amplifier portion. The pre amplification portion is directly controlled by the microcontroller 43 to set its power output level. The power amplification portion utilizes pulse width modulation encoding controlled by the microcontroller 43 to adjust its gain. Than that of the two portions determines the power level provided to the antenna.

A multiple input connection block 46 advantageously can include input/output modules or ports capable of accepting either digital or analog input including both pulse and encoded readings. A digital output board or relay 48 is provided for external device control. An analog input module 49 allows for monitoring of, for example, air-conditioning performance points such as pressure and temperature, providing municipalities the ability to create additional revenue sources.

Each meter data collector 41 preferably includes provisions for an RS-232/RS-485 module or suitable substitute which can be used to connect the meter data collector 41 to a high function meter with an RS-232/RS-485 port or any other device that can be controlled via RS 232/RS-485 or a suitable substitute. Data provided in a protocol message packet, described later, can be received over the network 32 and passed through the microcontroller 43 to a device connected to the RS-232/RS-485 module.

The meter data collector 41 also includes a real-time clock (not shown) which can be provided alarm interrupt settings including, for example, that for a one second downbeat timer, when to wake up and query the electric meter to retrieve history data, and a calibration register to synchronize the clock due to crystal inaccuracies. The alarm interrupt settings can be updated for use of a copy function, described later. Specifically, for implementation with respect to the electric meter 72, the real-time clock can provide a one second timer downbeat so that if the meter data collector 41 has not received a valid message an interrupt service routine can be initiated to recalibrate the transceiver. Additionally, the real-time clock can provide for a 25-50 millisecond timeout for acknowledgment messages and an ability to set a typically 75 millisecond timeout value for return of the message packet depending upon the size of the message packet and number of hops. The electric meter 72 implementation also uses the real-time clock to provide an interrupt to determine when to retrieve utility usage data from the electric meter 72. Also for example, for implementation with respect to the water meter 74, the real-time clock can provide one timer to indicate how often to interrogate the sensor 75 and another timer to indicate how often to provide data to the meter data collector 41.

The sensors, e.g., sensors 73, 75, 77, 79, generally known to those skilled in the art, are connected to the ports in the connection block 46 and can be tailored to the specific type of utility meter to be read. One sensor type, known as a “dry contact closure,” includes an electrical contact or switch when placed in a utility meter activates (opens or closes) at intervals that accurately reflect the energy or usage of the respective utility. The sensor is known as a “dry” contact because the utility meter does not supply any required voltage. That is, the voltage for this type of sensor originates in the meter data collector 41. Another type of sensor, known as a “pulse-type” metering device, generates a voltage pulse at intervals that accurately reflect the energy or utility usage of the respective utility. The voltage for this type of sensor can be supplied by the respective utility meter. Still another type of sensor, known as an “encoded-type” metering device, converts energy or utility usage data into a data stream that can be applied to a respective meter data collector 41. The voltage for this type of sensor can be supplied by the meter data collector 41. The dry contact closure metering device is most often used with gas and steam meters 76, 78. The pulse-type metering device is most often used with electrical meters 72 and some types of water meters 74. The encoded-type metering device is most often used on some types of water meters 74.

One or more of the sensors, e.g., sensors 73, 75, 77, 79, can be connected directly to the ports of multiple input connection block 46 using electrical conductors. According to alternative embodiments, one or more of the sensors can be connected using fiber optics, acoustics, wireless communication, or other methodologies known to those skilled in the art. The system 30 utilizing the meter data collectors 41 can allow for additional expansion of input/output as needed, including remote disconnect, appliance control for load curtailment, or outage detection, along with consumer value functions such as security, detection, or alarm notification. Electrical outage detection can be provided either through detecting a loss of electric power to a respective meter data collector 41 or detecting no electric utility usage for one or more utility meter data intervals. Advantageously, this provides electric utility managers near real-time customer outage data and negates customer outage reporting requirements. Correspondingly, leakage detection for a continuous leak of either gas or water can be indicated by detection of gas or water flow in approximately 100% of sampled utility meter data intervals. An intermittent leak can be determined by detecting an overly high percentage of sampled utility data intervals indicating usage. For example, an intermittent water leak can be indicated by water flow in, e.g., 48 of 96 utility data intervals.

The meter data collectors 41 can be powered through a conductor connected to or interfaced with internal components of the electric utility meter 72. The conductor is preferably an 18 gauge 4-wire cable, but can have different specifications known to those skilled in the art depending upon the power rating of the meter data collector 41. In an alternate embodiment of the present invention, the meter data collectors 41 can be connected to a conductor or cable having an electrical outlet interface (not shown), which can be plugged into a standard customer site electrical outlet. Other alternative embodiments for powering the meter data collectors 41 include use of batteries, solar power, wind power, and other methodologies known to those skilled in the art, or a combination thereof.

As perhaps best shown in FIGS. 1 and 2, the system 30 also includes a host computer 61 preferably positioned at a utility control center 60, remote from and in communication with the plurality of meter data collectors 41 through at least a subset of the plurality of meter data collectors 41, to receive the utility usage data for the plurality of meter data collectors 41. The host computer 61 can have memory 63 including or otherwise interfaced with a database 65 to store and process the utility usage data, thus providing for utility meter record storage and retrieval. The host computer 61 shown schematically in FIG. 2, for example, represents a computer system as small as that of a personal computer or as large as a server or server cluster or server farm and is not limited to any individual physical computer. If employed as a server, the server site may be deployed as a server farm or server cluster managed by a serving hosting provider. The number of computers or servers and their architecture and configuration may be increased based on usage, demand and capacity requirements for the system 30.

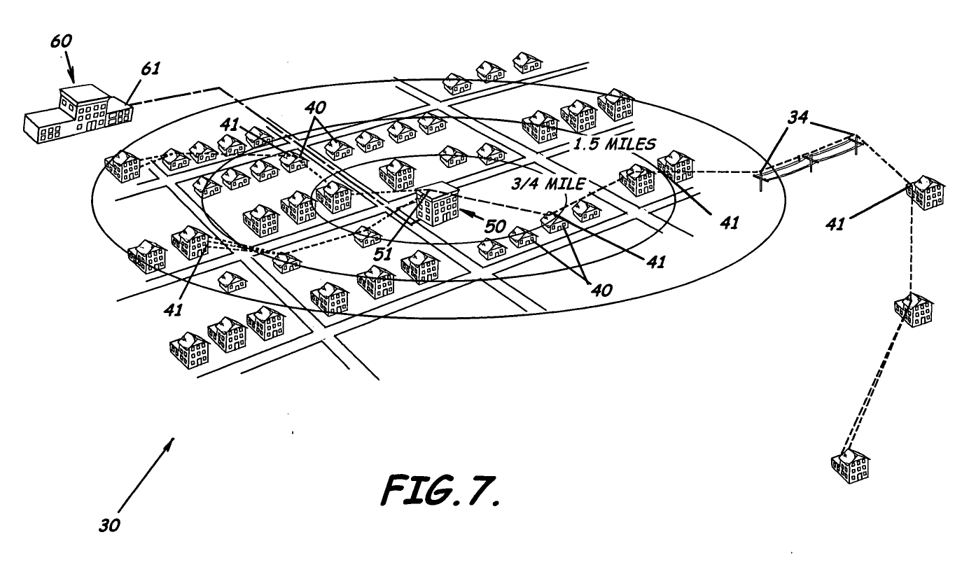

The utility usage data is initially temporarily stored in the memory module 45 of the respective meter data collector 41. The utility usage data can be date and time stamped to provide an accurate record of the utility meter read. The utility meter data can be continuously transmitted ad-hoc, stored for simultaneous transmission, and/or concentrated in batch-file format for transmission by a remote center or substation computer 53 or by an intelligent field host data collector 51′. This allows for data transfer over varying types of network configurations between the host computer 61 and field host data collectors 51, 51′, and/or meter data collectors 41, including transfer over the pre-existing public telephone networks (see FIG. 7).

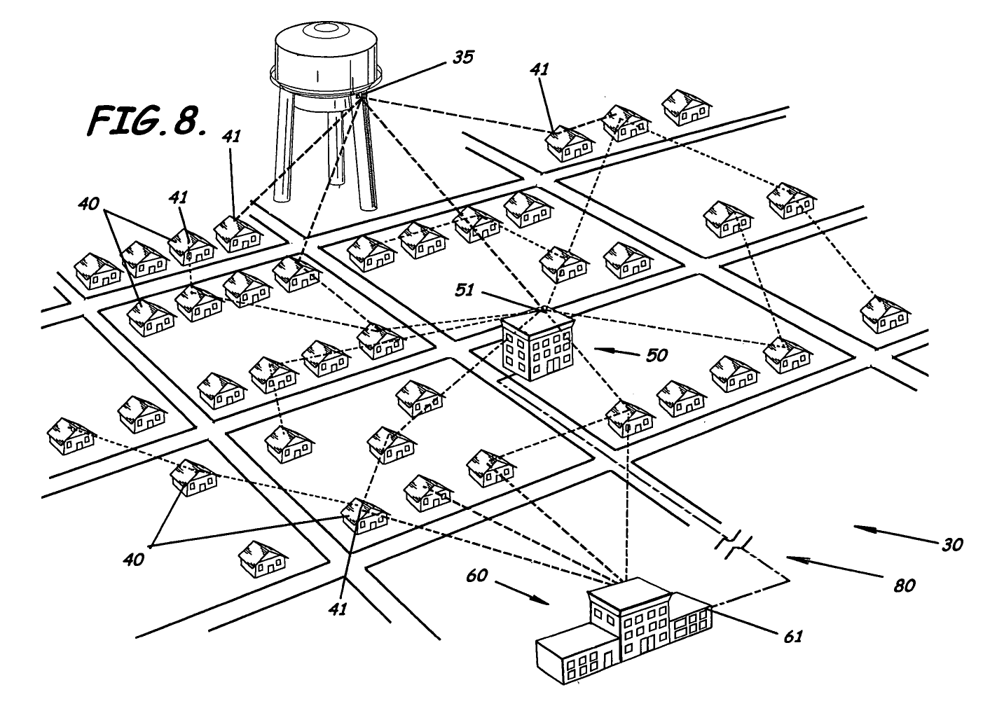

The utility usage data received by the host computer 61 can be stored in the database 65 and can be converted into a third-party-compatible database format, such as, for example, OLE DB compatible database file formats or other formats known to those skilled in the art, for input into existing customer information and billing systems (see also FIG. 10). The utility usage data can be compared to a temporal usage rate to formulate and store with the utility usage data a record of consumption totals. The database 65 can also include a table(s) to assign the meter data collectors 41 and/or field host data collectors 51, 51′, and intermediate collectors 34 (FIG. 7) or 35 (FIG. 8) at least one collector physical address, and can assign various utility usage data. The database 65 can also include next-read memory locations for each of the meter data collectors 41 indicating for each meter data collector 41 the next position in the memory 45 to retrieve history and usage data

The system 30 can also include one or more remote centers or substations 50 strategically located throughout the mesh communications network 32 and which, according to an embodiment of the present invention, can include a field host data collector 51 or alternatively field host data collector 51′, for gathering and/or processing the usage reading data. That is, the field host data collectors 51, 51′, which can be another meter data collector 41, can reside at a municipality infrastructure level such as a sub-station, pump station, or municipal office or other remote center 50. The field host data collectors 51, 51′, can be strategically positioned throughout a utility's coverage area to connect the network 32 to a wireless, cable, fiber, or telephony wide area network 80 to thereby establish multi-format and multi-medium communications between the host computer 61 and all available meter data collectors 41. As agent for the host, the field host data collectors 51, 51′ can also or alternatively request and store the utility usage data and can pass the instructions from the host computer 61 to the meter data collectors 41. The field host data collectors can have either pass-through or intelligent configurations. The pass-through field host data collectors 51 can provide direct contact between surrounding meter data collectors 41 and the host computer 61 or an intermediate computer associated with the pass-through field host data collector 51, such as, for example, a remote center or substation computer 53 that is in communication with the host computer 61 through the area network 80. Intelligent field host data collectors 51′ can collect meter data from surrounding meter data collectors 41 and/or other host field data collectors 51, 51′, and transmit the data to the host computer 61 either automatically or when requested to do so by the host computer 61.

Each of the plurality of meter data collectors 41 are preferably positioned spaced apart from and in cross-radio frequency communication with a subset of the plurality of meter data collectors 41, to thereby define a mesh communication network 32 (see, e.g., FIGS. 1 and 6). Through use of the mesh network 32, each of the meter data collectors 41 can both transmit utility usage data for associated utility meters and can transmit (relay) associated utility usage data for other surrounding meter data collectors 41. As shown in FIG. 7, in an embodiment of the present invention, the mesh network 32 can be divided into a plurality of radially expanding network levels whereby meter data collectors 41 at a first network level communicate with meter data collectors 41 at a second network level, and so on, through each network level. In an embodiment of the present invention, this can be accomplished while generally not communicating with meter data collectors 41 within the same network level, thereby reducing network congestion.

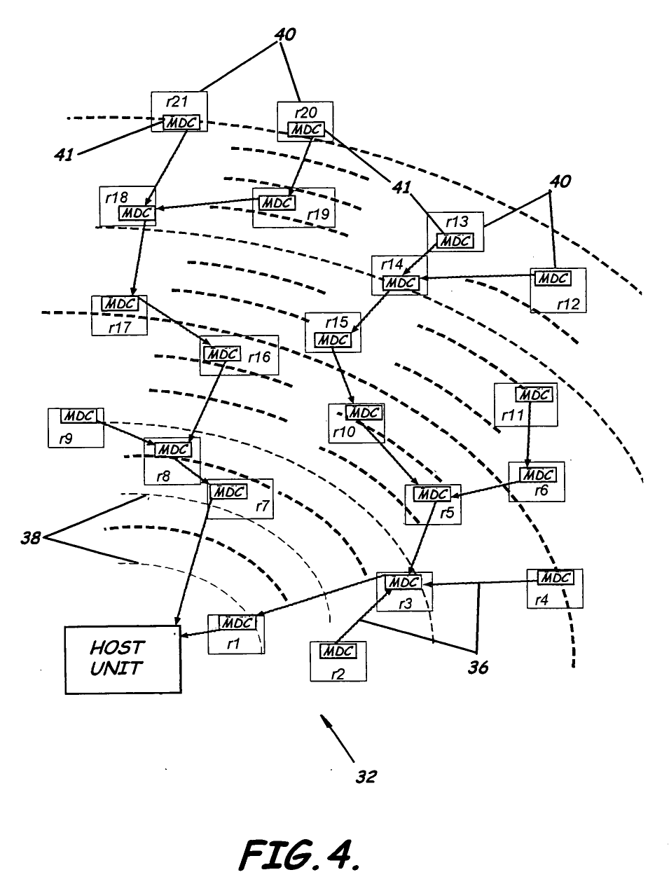

According to the preferred network configuration, the mesh communications network 32 is entirely RF based because an RF based network reduces data transmission cost, is flexible, and has low deployment costs. The configuration of the communications network 32 can be in the form of a point-to-multipoint network that can utilize, but that is not limited to utilizing, a frequency spectrum in a range acceptable to the Federal Communications Commission (FCC) such as 850-1000 mega-hertz (MHz), preferably 902-928 MHz, and/or 2.4-5.8 giga-hertz (GHz), preferably 2.4 GHz, which are characterized by having minimal regulatory and/or licensing requirements. In an embodiment of the present invention, the system 30 can use low-power RF transmissions. In a medium-range embodiment, the range between collectors 41 and the control center 60 or associated substations can be between 500-1500 meters from the meter data collectors 41. In a long-range embodiment, that distance can be between 2000-6000 meters. The telemetry module of the meter data collectors 41, intermediate collectors 34, 35, field host data collectors 51, 51′, and/or host computer 61 can include a medium to high range RF radio as understood by those skilled in the art, having a power rating preferably in a range of about 1 watt or greater. The telemetry module of the field host data collectors 51, 51′, can establish wireless communications 38 (see FIG. 4) to far reaching meter data collectors 41 and rake data back, or can establish communications with the various meter data collectors 41 through communication links 36, 37, (see FIG. 5) and also rake data back, as desired.

An embodiment of the present invention, the system 30 also allows for scalability as the addition of a new collector 41 at a new location that is merely tantamount to adding an additional “node” to the network 32. In an implementation, however, the network node level between the various nodes and either the control center 60 or a substation 50 can be limited to a preselected number, such as, for example, 15. The system 30 provides for both passive and dynamic execution of a meter read. In an embodiment, the collector 41 sends a current read to the control center 60 or substation 50 every 15 minutes, although the control center 60 can prompt for an additional read if greater than 15 minutes delay accuracy is required. In an embodiment of the present invention, the field host data collectors 51, 51′, can periodically poll the meter data collectors 41 located at the various customer locations, e.g., approximately every 15 minutes, and can receive a packet of information that includes meter identification data, consumption data, date and time stamp data, network statistics data, and other data, as desired. The intelligent field host data collectors 51′ can maintain a consumption file or database 55 (see FIG. 2) of all collected data received from each meter data collector 41 in its range. Alternatively, a remote center or substation computer 53 having a processor 57 can perform this function. The consumption/utility usage data can be displayed real-time at the utility control center 60 and/or at the remote center or substation 50.

As perhaps best shown in FIGS. 2 and 6, typically and functionally, if within range and not blocked or impeded by a physical structure or other obstacles, the utility usage data is forwarded directly to the host computer 61 which can be interfaced with a transceiver 67 (see FIG. 2) typically located in a utility control center 60, or indirectly forwarded through a field host data collector 51, 51′, typically located in a remote center or a substation 50 or through a meter data collector 41 interfaced directly with the host computer 61. If the meter data collector 41 is not within range, the utility usage data is forwarded to another meter data collector 41 associated with a location preferably closer to the host computer 61 or the field host data collector 51, 51′, or to an intermediate collector 34 (FIG. 7) or 35 (FIG. 8) to be forwarded either to the host computer 61, to the field host data collector 51, 51′, or to another meter data collector 41. In essence, the network structure can turn every collector 34, 35, 41, 51, 51′, into an individual network node capable of transmitting its respective utility usage data and relaying or repeating utility usage data from other “nodes.” Thus, an embodiment of the present invention provides a self-healing network having minimal infrastructure that alleviates a line-of-site issue whereby a physical structure may block the transmission of an individual collector 41.

The system 30 further can include a meter data collector program product 90 at least partially stored in the memory 63 of the host computer 61, the memory of the field host data collectors 51, 51′, and the memory of the remote computer 53, and/or in memory 45 of each meter data collector 41 to be executed by the respective processors 43, 53, 58, 58′. The meter data collector program product 90 can be in the form of microcode, programs, routines, and symbolic languages that provide a specific set or sets of ordered operations that control the functioning of the hardware and direct its operation, as known and understood by those skilled in the art. The meter data collector program product 90 includes a set of instructions particularly adapted to perform the operations of managing the mesh communication network 32 including varying the radio frequency frequencies and varying power level settings of at least portions of the mesh communication network 32 to overcome network interference or disruption, to thereby enhance mesh communication network performance. Note, see U.S. patent application Ser. No. 10/779,429, by Boaz titled “Automated Meter Reading System, Communication and Control Network for Automated Meter Reading, Meter Data Collector, and Associated Methods,” incorporated herein by reference in its entirety for a discussion of a methodology of performing frequency hopping.

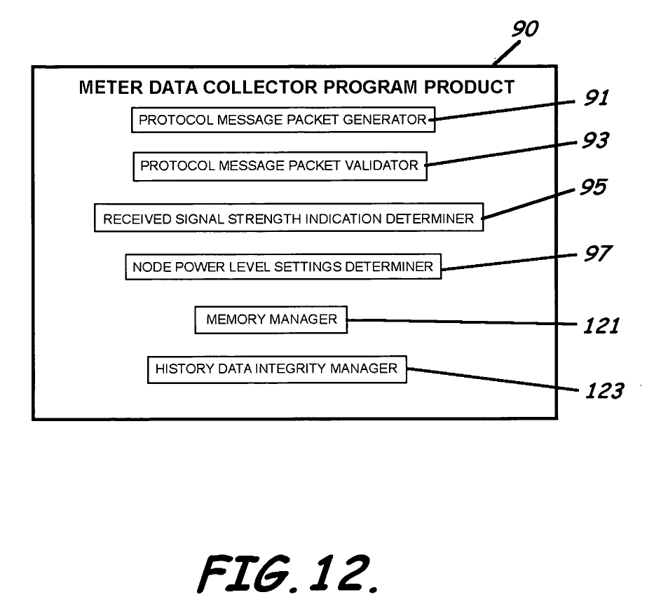

As shown in FIG. 12, according to an embodiment of the present invention, the meter data collector program product 90 can include various functional modules such as, for example, a protocol message packet generator 91, protocol message packet validator 93, received signal strength indication determiner 95, and a node power level settings determiner 97. Generally, the protocol message packet generator 91 can assemble a protocol message packet (described in more detail later) which includes routing instructions between meter data collectors 41, power level settings assignments for the meter data collectors 41, and received signal strength indication placeholders to receive from the meter data collectors 41 signal strength indications indicating the receive signal strength of the signal transmitting the protocol message packet. The protocol message packet validator 93 can perform a validation analysis, as known to those skilled in the art, on a routed version of the protocol message data packet to determine whether or not the protocol message packet contains corrupted data. The received signal strength indication determiner 95 can extract the receive signal strength indication from the protocol message packet in response to protocol message packet validation. The power level settings determiner 97, in response to the extracted received signal strength indications, can determine a substantially optimal power level setting for each of the meter data collectors 41 to thereby enhance individual mesh network segment strength and improve overall network performance.

According to an embodiment of the present invention, the host computer 61, for example, through meter data collector program product 90, can initiate communication messages to each of a plurality of meter data collectors 41 utilizing the above described message packet. A destination meter data collector 41, for example, can be: directly connected to the host computer 61; connected via radio frequency communications to another meter data collector 41 that is directly connected to the host computer 61; connected via radio frequency for up to a preselected number, e.g., 15, radio frequency repeater meter data collectors 34, 35, 41, to the meter data collector 41 directly connected to the host computer 61; connected via radio frequency communications to a field host data collector 51, 51′; connected via radio frequency communications to an intermediate collector 34 (FIG. 7) or 35 (FIG. 8) in radio frequency communication with another data collector 41, 51, 51′; and connected via various other combinations, thereof.

Upon initialization and periodically thereafter, the meter data collector program product 90 can perform the operation of forming a list of all available collectors 34, 35, 41, 51, 51′, and performs the operation of developing a network communications map from the list of collectors. More particularly, after the meter data collectors 41 and/or field host data collectors 51, 51′ and the primary host system 30 are in place, the host computer 61, through use of the meter data collector program product 90, can gather a list of available collectors 34, 35, 41, 51, 51′, which collectively can be considered to be communications nodes for the mesh communication network 32. This process is dynamic in nature and, at its conclusion, would produce a complete network communications map of a mesh network 32, ready to begin the job of data collection primarily through a communication network 80. As a mesh network 32, each meter data collector 41 generally has multiple communication paths between it and a local field host data collector 51, 51′, e.g., supporting up to 15 or more links or levels in a single path. The host computer or computer system 61, preferably located at the central office 60, for example, can poll the meter data collectors 41 and/or field host data collectors 51, 51′, typically on a revolving schedule 24 hours a day, 7 days a week, and 365/366 days a year.

The meter data collector program product 90 can include instructions, that when executed, function to perform the operations of collecting the utility usage data. In an embodiment of the present invention, in response to the polling received from the host computer 61, the meter data collectors 41 that are closer to either the host transceiver 67 (FIG. 2) or field data collectors 51, 51′, can rakingly collect data from more distant meter data collectors 41, so that utility usage data is collected from each meter data collector 41 throughout the mesh communications network 32 and routed to the host computer 61. The utility usage data received by the host computer 61 can then be converted into a customer compatible database file format, as understood by those skilled in the art, for input into existing customer information and billing systems. The meter data collector program product 90, or other software or program product, can further provide a Web server (not shown) the data needed to populate an interactive customer web page (not shown) with meter real-time utility usage information including a near real-time current meter reading, utility usage charts, daily, monthly, and yearly historical meter readings and comparisons. Advantageously, such data can help reduce billing disputes and customer service overhead costs, and can help improve customer energy management.

In the preferred embodiment of the present invention, the network program product 90 associated with a host computer or server 61 and associated with each meter data collector 41 in the system 30 can include a preselected protocol, such as, for example an application layer protocol positioned at level 7 of an OSI model as understood by those skilled in the art, which provides communication between devices connected on different types of buses or networks. This protocol can also allow the collectors 34, 35, 41, 51, 51′, for example, to communicate with each other and the host computer or server 61 or substation computers 53. The preselected protocol can be a request/reply protocol or a “ping” which can offer services specified by message type.

The preselected protocol message packet can be used to initiate a preselected transaction. The message type can indicate to a slave application what kind of action to perform. The size of the preselected protocol message packet is generally device dependent and can have, for example, a maximum of 256 bytes. Embodiments having other sizes are, however, within the scope of the present invention. In an embodiment of the present invention, the preselected protocol uses a focused representation for addresses and data items. This focus, for example, can occur such as when a numerical quantity larger than a single byte is transmitted; the most significant byte being sent first.

The preselected protocol includes a non-routed protocol frame and a routed protocol frame. In an embodiment, the routed protocol frame includes the following elements: a Start of Message (SOT), Message Type (MT), Message Sequence Number (MSN), Message Length (ML), Message Date Time (MDT), Routing Source Power Level (RSPL), Routing Source Frequency Index (RSFI), Routing Source Node Identification (RSID), Routing Source Received Signal Strength Indication (RSRSSI), Routing Destination Power Level (RDPL), Routing Destination Frequency Index (RDFI), Routing Destination Node Identification (RDID), Routing Destination Received Signal Strength Indication (RDRSSI), Routing Gateway Information (RGI), Routing Gateway Power Level (RGPL), Routing Gateway Frequency Index (RGFI), Routing Gateway Node Identification (RGID), Routing Gateway Received Signal Strength Indication (RGRSSI), Payload Data (PD), and Cyclical Redundancy Check (CRC).

The general and sub-categories describing the routed protocol frame are shown, as follows:

| | | | | | | |
|---|---|---|---|---|---|---|
| Preamble | Source | Destina- | Gateway | Gateways | Payload | CRC |
| | | tion | Hops | | (PD) | |

Preamble Information:

| | | | | |
|---|---|---|---|---|
| SOT | MT | MSN | ML | MDT |

Source Information:

| | | | |
|---|---|---|---|
| RSPL | RSFI | RSID | RSRSSI |

Destination Information:

| | | | |
|---|---|---|---|
| RDPL | RDFI | RDID | RDRSSI |

Routing Gateway Hop Information (Number of Gateways or Hops):

RGI

Gateway Information (for Each Gateway):

| | | | | |
|---|---|---|---|---|
| RGPL | RGFI | RGID | RGRSSI₁ | RGRSSI₂ |

Payload Data:

PD

Cyclical Redundancy Check:

CRC

The non-routed protocol frame is nearly identical except for does not include the gateway information.

| | | | | | |
|---|---|---|---|---|---|
| Preamble | Source | Destination | Gateway Hops | Payload | CRC |

The following have an example of the Protocol Frame Element Definitions:

| Element | Description | Length | Range | Comments |
|---|---|---|---|---|
| SOT | Start of Transmission | 1 byte | [0xEE] | Constant Value |
| MT | Message Type | 1 byte | | See below |
| MSN | Message Sequence Number | 1 byte | [0x00-0xFF] | Message originator connection |
| | | | | dependent incremental message |
| | | | | identification number. |
| ML | Message Length | 1 byte | [0x00-0xFF] | Device Dependent |
| MDT | Message Date Time | 4 bytes | [0x00000000-0xFFFFFFFF] | Message Date Time Stamp |
| RSPL | Routing Source Power Level | 1 byte | [0x00-0xFF] | Transmit Power Level |
| RSFI | Routing Source Frequency | 1 byte | [0x00-0xFF] | Transmit Frequency |
| | Index | | | |
| RSID | Routing Source Node | 4 bytes | [0x00000000-0xFFFFFFFF] | Message originator unique |
| | Identification | | | unsigned long identification |
| | | | | number. |
| RSRSSI | Routing Source Received | 1 byte | [0x00-0xFF] | Strength of Received |
| | Signal Strength | | | Transmission |
| RDPL | Routing Destination Power | 1 byte | [0x00-0xFF] | Transmit Power Level |
| | Level | | | |
| RDFI | Routing Destination | 1 byte | [0x00-0xFF] | Transmit Frequency |
| | Frequency Index | | | |
| RDID | Routing Destination Node | 4 bytes | [0x00000000-0xFFFFFFFF] | Message destination unique |
| | Identification | | | unsigned long identification |
| | | | | number. |
| RDRSSI | Routing Destination | 1 byte | [0x00-0xFF] | Strength of Received |
| | Received Signal Strength | | | Transmission |
| RGI | Routing Gateway Information | 4 bits | [0x0-0xF] | High nibble (RGN)--Number of |
| | | | | Routing Gateways Required |
| | | | | Transmitting Message from |
| | | | | Source Node to Destination |
| | | | | Node. |
| | | 4 bits | [0x0-0xF] | Low nibble--Current Routing |
| | | | | Gateway Index While |
| | | | | Transmitting Message from |
| | | | | Source Node to Destination Node. |
| RGPL | Routing Gateway Power | 1 byte | [0x00-0xFF] | Transmit Power Level |
| (×RGN) | Level | | | |
| RGFI | Routing Gateway Frequency | 1 byte | [0x00-0xFF] | Transmit Frequency |
| (×RGN) | Index | | | |
| RGID | Routing Gateway Node | 4 bytes | | Routing Source Identification |
| (×RGN) | Identifications | | | Number of each Routing |
| | | | | Gateway along path from source |
| | | | | node to destination node. |
| RGRSSI₁ | Routing Gateway Received | 1 byte | [0x00-0xFF] | Strength of Received |
| (×RGN) | Signal Strength | | | Transmission from First |
| | | | | Adjacent Node |
| RGRSSI₂ | Routing Gateway Received | 1 byte | [0x00-0xFF] | Strength of Received |
| (×RGN) | Signal Strength | | | Transmission from Second |
| | | | | Adjacent Node |
| PD | Payload Data | | | Payload Data is dependent |
| | | | | upon message type. |
| CRC | Cyclical Redundancy Check | 1 byte | [0x00-0xFF] | CRC-16 Polynomial Mask 0x1021 |

According to an embodiment, the preselected protocol can support three levels of message security. Each security level is validated by an up to eight-byte security password. Each security level password byte may be any ASCII character. Each security level password is stored relevant to the routing source identification number. For the purpose of CRC calculation only, the security level password is appended to the message.

In this embodiment, the preselected protocol frame Message Type element is a bit-significant field and includes the following elements: Security Level (SL), Message Type (MT), Read or Write Direction Flag (R#/W), and Acknowledgement Flags (ACK).

| | | | |
|---|---|---|---|
| SL | MT | R#/W | ACK |

The following are an example of Message Type Byte Element Definitions:

| Element | Description | Length | Range | Comments |
|---|---|---|---|---|
| SL | Security Level | 2 bits | [0x00-0x03] | 0x00: None |
| | | | | 0x01: Security Level 1 |
| | | | | 0x02: Security Level 2 |
| | | | | 0x03: Security Level 3 |
| MT | Message Type | 3 bits | [0x00-0x07] | See Message Type |
| | | | | Definition, Below |
| R#/W | Read or Write | 1 bit | [0x00-0x01] | 0x00: Read |
| | Direction Flag | | | 0x01: Write |
| ACK | Acknowledgement | 2 bits | [0x00-0x03] | 0x00: Send |
| | Flags | | | 0x01: Acknowledge |
| | | | | 0x02: Response |
| | | | | 0x03: Negative Acknowledge |

In an embodiment, when a master application directly addresses a slave application (non-routing), the slave application processes the message type specified action and responds by setting the acknowledge binary code to “Response” (0x02) within the message type frame element. When a master application addresses a slave application via routing, the first gateway node will route the message to the next gateway node and respond to the master application by setting the acknowledge binary code to “Acknowledge” (0x01) within the message type frame element. When the destination node receives the routed message, the destination node processes the message type specified action and responds by setting the acknowledge binary code to “Response” (0x02) within the message type frame element. If the message fails to respond from the destination node, the gateway node of last transmission will originate and route the return message to the source node by setting the acknowledge binary code to “Negative Acknowledge” (0x03) within the message type frame element.

In an embodiment, the following preselected protocol message types, for example, can be supported:

| Message | Message Type | Read | Write | Security |
|---|---|---|---|---|
| Type | Description | Supported | Supported | Level |
| 0x00 | Control | Yes | Yes | 0x00-0x03 |
| 0x01 | Control Route | Yes | Yes | 0x00-0x03 |
| | (Raking) | | | |
| 0x02 | ANSI | Yes | Yes | 0x00-0x03 |
| 0x03 | Route (Directly | Yes | Yes- | 0x00-0x03 |
| | Back) | | | |
| 0x04 | Pass Through | Yes | Yes | 0x00-0x03 |
| | (RS-232 Port) | | | |
| 0x05 | Pass Through-ANSI | Yes | Yes | 0x00-0x03 |
| 0x06 | File | Yes | Yes | 0x00-0x03 |
| 0x07 | Reserved | — | — | 0x00-0x03 |

The preselected protocol frame element includes a payload data section. The payload data section of the message packet sent from master application to slave application contains information that the master application uses to take the action defined by the message type. The payload data section of the message packet may be nonexistent (of zero length) in certain kinds of requests. In such case the slave application does not require any additional information. The message type in this instance specifies the action. The following details the payload data requirements for each of the supported message types. Data registers are referenced by control type and control index. For example: To reference the first analog input point the control type would be 0x02 and the control index would be 0x00.

Examples of Control Data Types are as follows:

| Control | Control | | |
|---|---|---|---|
| Data Type | Description | Data Type | Data Range |
| 0x00 | Discrete Input | Byte | [0x00-0x01] |
| 0x01 | Discrete Output | Byte | [0x00-0x01] |
| 0x02 | Analog Input | Unsigned Integer | [0x00-0xFFFF] |
| 0x03 | Analog Output | Unsigned Integer | [0x00-0xFFFF] |
| 0x04 | Date Time | See below | |
| 0x05 | Counter | Unsigned Log | [0x00-0xFFFFFFFF] |
| 0x06 | Reserved | | |
| 0x08 | Reserved | | |
| 0x09 | Reserved | | |
| 0x10 | History Record | See below | |
| 0x11 | Event Record | See below | |

Discrete Control Data Types 0x00 and 0x01 are packed into bytes. As understood by those skilled in the art, a master query must divide the requested point index by 0x08 to obtain the proper control data index. For example: A master query for the status of discrete input 0x09 must request control data type 0x00 and index 0x01. The slave response data value bit 1 will contain the status of discrete input 0x09.

The most significant bit of the Control Data Type is an exception response flag. For example: if a control message requests an index that is not supported by the slave device, the slave device response will echo the requested data type and set the most significant bit. The byte following the control index will be a single byte Control exception code regardless of data type. Control exception codes are defined below. The Control Date Time data type can be defined as the number of seconds from the host server reference date and time.

The Control History Record data type is defined as the following:

| | | Control Data | | |
|---|---|---|---|---|
| Offset | Description | Type | Data Type | Comment |
| 0x00 | Data Time | Control Date | Unsigned | Control date |
| | Stamp | Time | Long | time stamp of |
| | | | | stored data value |
| 0x04 | Data Value | Control Data | Byte | Control data |
| | Type | Type | | type of stored |
| | | | | data value |
| 0x05 | Data Value | Control Data | — | Control Data |
| | | Value | | value |

The Control Event Record data type can be defined as the following:

| | | Control Data | | |
|---|---|---|---|---|
| Offset | Description | Type | Data Type | Comment |
| 0x00 | Data Time Stamp | Control Date | Unsigned | Control date |
| | | Time | Long | time stamp of |
| | | | | stored data value |
| 0x04 | Event Type Code | Event Type | Byte | Event Type |
| | | | | Code Reserved |
| | | | | Always 0x00. |
| 0x05 | Data Value Type | Control Data | Byte | Control data |
| | | Type | | type of stored |
| | | | | data value |
| 0x06 | Data Old Value | Control Data | — | Control data |
| | | Old Value | | old value |
| — | Data New Value | Control Data | — | Control data |
| | | New Value | | new value |

The Control exception codes can include the following:

Control Exception Codes

| Code | Name | Meaning |
|---|---|---|
| 0x00 | ILLEGAL | The requested operation to perform |
| | FUNCTION | on the referenced data type is not |
| | | supported by the end device or not |
| | | permitted due to security level access. |
| 0x01 | ILLEGAL DATA | The data type received in the query |
| | TYPE | is not an allowable type for the |
| | | slave device. |
| 0x02 | ILLEGAL DATA | The data index received in the |
| | INDEX | query is not an allowable index for |
| | | the slave device. |
| 0x03 | ILLEGAL DATA | The value contained in the query |
| | VALUE | data field is not an allowable |
| | | value for the slave device. |
| 0x04 | SLAVE DEVICE | The slave device is engaged in |
| | BUSY | processing a long-duration program |
| | | command. The master device should |
| | | retransmit the message later when |
| | | the slave device is free. |
| 0x05 | SLAVE DEVICE | An unrecoverable error occurred |
| | FAILURE | while the slave device was |
| | | attempting to perform the requested |
| | | action. |

In an embodiment, the control message type includes a control read and a control write message type. The control read message type is used to read data registers from a slave device. Read access to data registers is dependent upon security level as defined as follows:

| Control | Control | | Security |
|---|---|---|---|
| Data Type | Description | Data Type | Levels |
| 0x00 | Discrete Input | Byte | 0x00-0x03 |
| 0x01 | Discrete Output | Byte | 0x00-0x03 |
| 0x02 | Analog Input | Unsigned Integer | 0x00-0x03 |
| 0x03 | Analog Output | Unsigned Integer | 0x00-0x03 |
| 0x04 | Date Time | See above | 0x02-0x03 |
| 0x05 | Counter | Unsigned Long | 0x01-0x03 |
| 0x06 | Reserved | — | — |
| 0x07 | Reserved | — | — |
| 0x08 | Reserved | — | — |
| 0x09 | History Record | See above | 0x01-0x03 |
| 0x10 | Event Record | See above | 0x01-0x03 |

In an embodiment, the payload data element of the control read message frame includes a master and a slave. The master can include the elements of:

| | | | | | |
|---|---|---|---|---|---|
| COUNT_{N} | CT₁ | CI₁ | . . . | CT_{N} | CI_{N} |

where for each requested data value N, the control read message from the master must designate the control data type and control data index.

For history and event control data types, a four byte pointer is provided to indicate the location of, for example, a history or event in memory:

| | | | | | | | |
|---|---|---|---|---|---|---|---|
| COUNT_{N} | CT₁ | CI₁ | PTR₁ | . . . | CT_{N} | CI_{N} | PTR_{N} |

| Element | Description | Length | Range | Comments |
|---|---|---|---|---|
| COUNT_{N} | Point Quantity | 1 byte | [0x00-0xFF] | Device Message Length Dependent |
| CT_{N} | Control Data Type | 1 byte | | See above |
| CI_{N} | Control Data Index | 1 byte | [0x00-0xFF] | Device Dependent |
| PTR_{N} | Memory Address | 4 bytes | [0x00000000-0xFFFFFFFF] | Start Read Location |

The slave can include the elements of:

| | | | | | | | |
|---|---|---|---|---|---|---|---|
| COUNT_{N} | CT₁ | CI₁ | CV₁ | . . . | CT_{N} | CI_{N} | CV_{N} |

where for each requested data value N, the control read message response from the slave must designate the control data type, control data index, and control data value.

For history and event control data types, a four byte pointer is provided to indicate the location of, for example, a history or event in memory:

| | | | | | | | | | |
|---|---|---|---|---|---|---|---|---|---|
| COUNT_{N} | CT₁ | CI₁ | CV₁ | PTR₁ | . . . | CT_{N} | CI_{N} | CV_{N} | PTR_{N} |

| Element | Description | Length | Range | Comments |
|---|---|---|---|---|
| COUNT_{N} | Point Quantity | 1 byte | [0x00-0xFF] | Slave Device Message Length Dependent |
| CT_{N} | Control Data Type | 1 byte | | See above |
| CI_{N} | Control Data Index | 1 byte | [0x00-0xFF] | Slave Device Dependent |
| CV_{N} | Control Data Value | | | See above |
| PTR_{N} | Memory Address | 4 byte | [0x00000000-0xFFFFFFFF] | Last or Next Read Location |

In this embodiment, the control write message type is used to write values to data registers in a slave device. Write access to data registers is dependent upon security level as defined as follows:

| Control | Control | | Security |
|---|---|---|---|
| Data Type | Description | Data Type | Levels |
| 0x00 | Discrete Input | Byte | Exception |
| | | | Code 0x00 |
| 0x01 | Discrete Output | Byte | 0x01-0x03 |
| 0x02 | Analog Input | Unsigned Integer | Exception |
| | | | Code 0x00 |
| 0x03 | Analog Output | Unsigned Integer | 0x01-0x03 |
| 0x04 | Date Time | See Control Date | 0x02-0x03 |
| | | Time structure | |
| | | definition | |
| 0x05 | Counter | Unsigned Long | 0x02-0x03 |
| 0x06 | Reserved | | |
| 0x07 | Reserved | | |
| 0x08 | Reserved | | |
| 0x09 | History Record | See Control | Exception |
| | | History Record | Code 0x00 |
| | | structure | |
| | | definition | |
| 0x10 | Event Record | See Control | Exception |
| | | Event Record | Code 0x00 |
| | | structure | |
| | | definition | |

In an embodiment, the payload data element of the control write message frame includes a master and a slave. The master can include the elements of:

| | | | | | | | |
|---|---|---|---|---|---|---|---|
| COUNT_{N} | CT₁ | CI₁ | CV₁ | . . . | CT_{N} | CI_{N} | CV₁ |

where for each requested data value N, the control write message from the master must designate the control data type, control data index, and control data value.

The slave can include the elements of:

| | | | | | |
|---|---|---|---|---|---|
| COUNT_{N} | CT₁ | CI₁ | . . . | CT_{N} | CI_{N} |

where for each requested data value N, the control write message response from the slave must acknowledge the control data type and control data index.

| Element | Description | Length | Range | Comments |
|---|---|---|---|---|
| COUNT_{N} | Point Quantity | 1 byte | [0x00-0xFF] | Slave Device |
| | | | | Message Length |
| | | | | Dependent |
| CT_{I} | Control Data | 1 byte | | See above |
| | Type | | | |
| CI_{I} | Control Data | 1 byte | [0x00-0xFF] | Slave Device |
| | Index | | | Dependent |
| CV_{I} | Control Data | | | See above |
| | Value | | | |

According to an embodiment of the present invention, the control message type can provide broadcast capability. This broadcasted message is defined for increased efficiency of network bandwidth by allowing the collection/control of multiple end node devices. The Control command may be routed through the network and can be transmitted from the device identified by the routing destination identification number field. The device can use a routing destination identification number of 0x00000000 to transmit the control message to all of the nodes. Such broadcast message can be used to read data registers from multiple slave devices.

According to an embodiment of the present invention, a Control Route message type, defined for increased efficiency of network bandwidth by allowing the collection of intermediate routing gateway data while acquiring end node data. Data types, exception codes, and security codes for the Control Route message types are defined with the Control message type.

The Control Route message type includes a Control Route Read and a Control Route Write message type. The control route read message type is used to read data registers from a slave device and each routing gateway node.

The payload data element of the control route read message frame also can include a master and a slave. The master can include the elements of:

| | | | | | |
|---|---|---|---|---|---|
| COUNT_{N} | CT₁ | CI₁ | . . . | CT_{N} | CI_{N} |

where for each requested data value N, the control read message from the master must designate the control data type and control data index.

For history and event control data types, a four byte pointer is provided to indicate the location of, for example, a history or event in memory:

| | | | | | | | |
|---|---|---|---|---|---|---|---|
| COUNT_{N} | CT₁ | CI₁ | PTR₁ | . . . | CT_{N} | CI_{N} | PTR_{N} |

The slave can include the elements of:

| | | | | | | | | | | | |
|---|---|---|---|---|---|---|---|---|---|---|---|
| COUNT_{N*X} | CT₁ | CI₁ | CV₁ | . . . | CT₁₁ | CI₁₁ | CV₁₁ | . . . | CT_{NX} | CI_{NX} | CV_{NX} |

where for each requested data value N, the control read message response from the slave (and each routing gateway node X) must designate the control data type, control data index, and control data value.

For history and event control data types, a four byte pointer is provided to indicate the location of, for example, a history or event in memory:

| COUNT_{N*X} | | CT₁ | CI₁ | CV₁ | PTR₁ | . . . | | |
|---|---|---|---|---|---|---|---|---|
| CT₁₁ | CI₁₁ | CV₁₁ | PTR₁₁ | . . . | CT_{NX} | CI_{NX} | CV_{NX} | PTR_{NX} |

| Element | Description | Length | Range | Comments |
|---|---|---|---|---|
| COUNT_{N} | Point Quantity | 1 byte | [0x00-0Xff] | Device Message |
| | | | | Length Dependent |
| CT₁ | Control Data | 1 byte | | See above: Control |
| | Type | | | Data Types |
| CT_{1X} | Control Data | 1 byte | | Control Data Type |
| | Type | | | for routing gateway |
| | | | | node X |
| CI₁ | Control Data | 1 byte | [0x00-0xFF] | Device Dependent |
| | Index | | | |
| CI_{1X} | Control Data | 1 byte | | Control Data Index |
| | Index | | | for routing gateway |
| | | | | node X |
| CV₁ | Control Data | | | See above: Control |
| | Value | | | Data Types |
| CV_{1X} | Control Data | 1 byte | | Control Data Value |
| | Value | | | for routing gateway |
| | | | | node X |
| PTR₁ | Memory Address | 4 byte | | Last or Next Read |
| | | | | Memory Location |
| PTR_{1X} | Memory Address | 4 byte | | Memory Address for |
| | | | | routing gateway |
| | | | | node X |

The control route write message type is used to write data registers from a slave device and each routing gateway node.

The payload data element of the control route write message frame can include a master and a slave. The master can include the elements of:

| | | | | | | | |
|---|---|---|---|---|---|---|---|
| COUNT_{N} | CT₁ | CI₁ | CV₁ | . . . | CT_{N} | CI_{N} | CV₁ |

where for each requested data value N, the control route write message from the master must designate the control data type, control data index, and control data value.

The slave can include the elements of:

| | | | | | | | | | | | | | |
|---|---|---|---|---|---|---|---|---|---|---|---|---|---|
| COUNT_{N*(X+1)} | CT₁ | CI₁ | . . . | CT₁₁ | CI₁₁ | . . . | CT_{N1} | CI_{N1} | CT_{1X} | CI_{1X} | . . . | CT_{NX} | CI_{NX} |

where for each requested data value N the control write message response from the slave (and each routing gateway node X) must acknowledge the control data type and control data index.

| Element | Description | Length | Range | Comments |
|---|---|---|---|---|
| COUNT_{N} | Point Quantity | 1 byte | [0x00-0xFF] | Device Message |
| | | | | Length Dependent |
| CT₁ | Control Data | 1 byte | | See above: |
| | Type | | | Control Data |
| | | | | Types |
| CT_{1X} | Control Data | 1 byte | | Control Data |
| | Type | | | Type for |
| | | | | routing gateway |
| | | | | node X |
| CI₁ | Control Data | 1 byte | [0x00-0xFF] | Device Dependent |
| | Index | | | |
| CI_{1X} | Control Data | 1 byte | | Control Data |
| | Index | | | Index for routing |
| | | | | gateway node X |
| CV₁ | Control Data | | | See above: |
| | Value | | | Control Data |
| | | | | Values |
| CV_{1X} | Control Data | 1 byte | | Control Data |
| | Value | | | Value for routing |
| | | | | gateway node X |

In an embodiment of the present invention, the ANSI message type allows for interfacing with, for example, an external device connected to the RS-232/RS-485 connection or through an OEM header which is compatible with the ANSI protocol. Correspondingly, the ANSI message type indicates that the payload data element is configured to support instructions provided in the ANSI format.

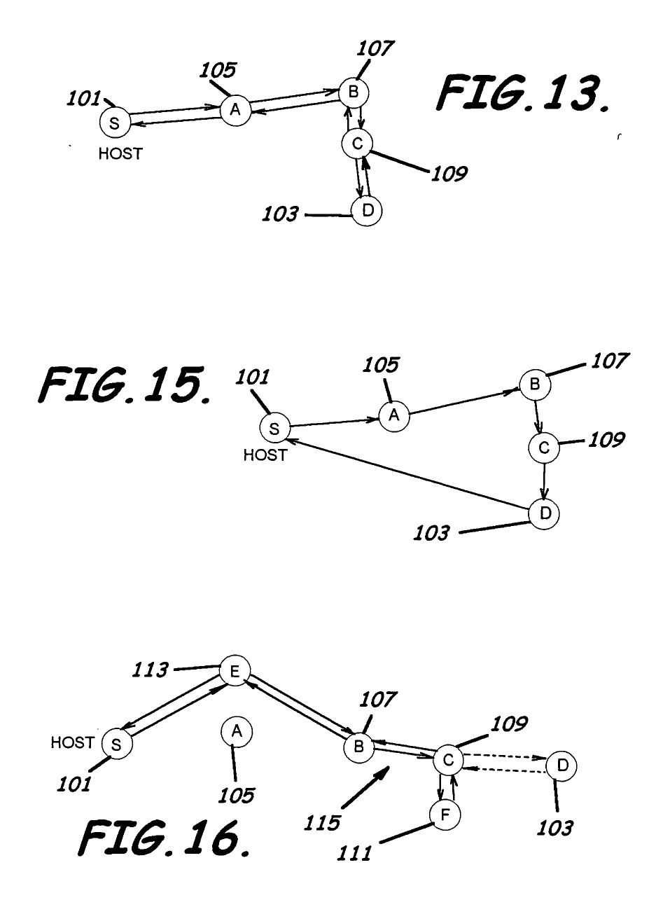

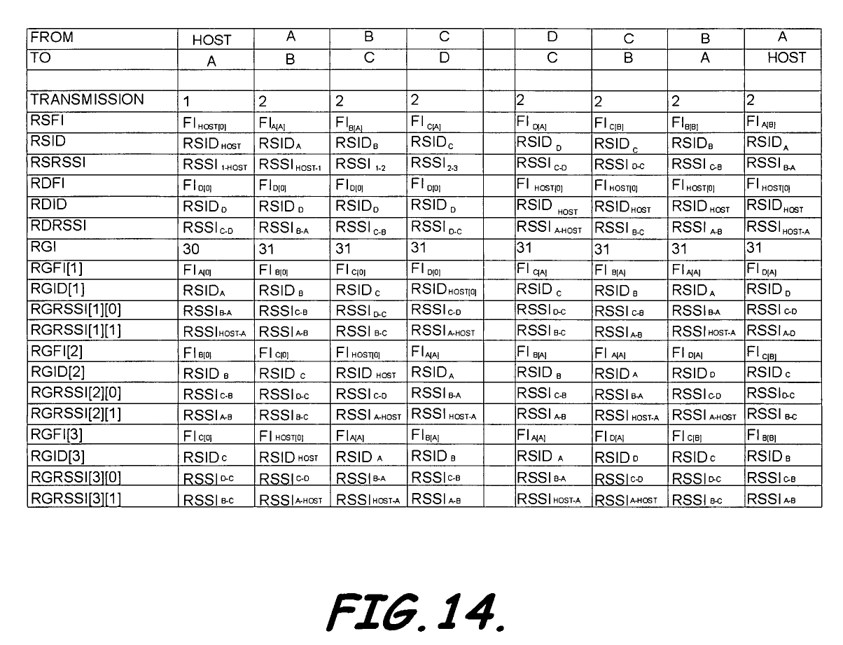

In an embodiment of the present invention, the Route message type indicates to the destination node to route the packet directly back to the source node. That is, the next leg of the transmission is between the destination node and the source node. To indicate such routing, the low nibble of the routing gateway information or RGI is not reset to zero to indicate the multipath return trip as is accomplished with the control message type. For example, in a pathway having three intermediate gateways such as that shown in FIGS. 13 and 14, the RGI will remain at 0x33 rather than the reset to 0x30 for the reverse-return route back to the source node as that shown in FIG. 14.

In an embodiment of the present invention, the Pass-through message type indicates that the payload data is to be pass-through, for example, the RS-232 port, and includes a protocol that is not control or ANSI type. Similarly, the Pass-through ANSI message type indicates that the payload data is to be pass-through, for example, the RS-232 port, but data to be received is configured utilizing a protocol that is ANSI type format/standard.

The file message type can be used to provide instructions including those to perform copy and fill command functions to, and/or receive data from, various meter data collector components such as, for example, fixed random access memory, flash memory, and real-time clock, etc., described in more detail later.

According to an embodiment of a system of collecting utility meter data, a plurality of meter data collectors 41 defining nodes are deployed in or adjacent one or more utility meters. Each of the utility meters can be mounted to a different building or different portion of the same building. Each of the meter data collectors 41 can be polled from a collection computer positioned remote from the meter data collectors 41 and each meter data collector 41 can transmit meter data to the collection computer in response to the polling. The collection computer can be a field collection unit 51, 51′, or the host computer 61, for example, which can be positioned remote from and in communication with a field collection unit 51, 51. Functionally, data is acquired from the sensor interfaced with its respective individual utility meter. The utility usage data is obtained by the meter data collector 41, from the meter sensor and preferably temporarily stored in the memory module 45 of the respective meter data collector 41 for later transmission along with a next read-memory location.

The host computer 61, for example, can initiate communication messages to each of the plurality of destination meter data collectors 41. A destination meter data collector 41, for example, can be: (1) directly connected to the host computer 61; (2) connected via radio frequency from the meter data collector 41 directly connected to the host computer 61, or (3) connected via radio frequency for up to a preselected number, e.g., 15, radio frequency repeater meter data collectors 41 to the meter data collector 41 directly connected to the host computer 61. In order to reduce network congestion, the utility meter data can be raked in from the meter data collectors 41. For example, a first meter data collector 41 can read the utility meter data from memory 45 and/or directly transmit the sensed utility meter data to a second meter data collector 41, the second meter data collector 41 can transmit the utility meter data of the first and second meter data collectors 41 to a third meter data collector 41, and the third meter data collector 41 can transmit utility meter data of the first, second, and third meter data collector 41 to the field collection unit 51, 51′, for example, or directly to the host computer 61 if equipped for wireless communication. The utility meter data can also be transmitted from the field collection unit 51 to a router of a communication network service provider, can communicate the utility meter data through a communication network 80 associated with the communication network service provider to a host computer 61 in communication with the communication network 80.

According to an embodiment of the present invention, when each meter data collector 41 is deployed, the actual geographic position, e.g., latitude, longitude, and elevation, is recorded. Correspondingly, the distance between any two meter data collectors 41 (nodes) is known. In view of such distance data, the meter data collector program product 90 or other program product or software using a known (measured or derived) free space attenuation between the respective node pairs, a minimum transmission power level setting can be readily determined for each set of node pairs to allow data transmission between nodes. If such power setting between a specific node pair is less than the maximum signal power output of the nodes, e.g., telemetry module 44, the node pair under an ideal scenario should form a usable leg of the mesh network 32. Obstacles and various other environmental factors, however, typically result in a formation of a network topography different from that of the ideal scenario. Note, although specifically referring to meter data collectors 41, for simplicity, the foregoing and following discussion applies regarding forming network segments between each of the various types of nodes including intermediate collectors 34, 35, meter data collectors 41, field hosts 51, 51′, remote computer 53, and the primary host 61.

Advantageously, the system 30 is robust in that through a refresh process individual segments of the network 32 can be continuously analyzed in order to ensure availability of the maximum number of segments possible. For example, if the system 30 through, e.g., the meter data collector program product 90, determined that a specific node pair should be a usable segment of the mesh network 32, i.e., the nodes of the node pair are within the radius of the weakest transmitter of the node pair, but due to environmental conditions was deemed not usable, the system 30 can continuously analyze the segment to determine if it has become usable. Obstacles such as, for example, temporary structures, vehicles, or natural obstructions, such as leaves on trees, or conflict with other emitting devices can cause a disruption in a specific segment. Such structures or vehicles can be moved, the leaves of the trees may fall or the tree may be trimmed or cut down, conflicting emitters may be shut off. Correspondingly, a segment previously deemed available may become unavailable due to such temporary structures, natural obstructions, conflicting emitters, or other environmental factors. Utilization of frequency hopping, for example can be employed to bypass conflicting emitters. With respect to physical obstacles, adjustment in the output power of the signal between node pairs may be sufficient to compensate for the attenuation over that of the normal free space attenuation resulting from the physical obstruction. Additionally, for node pairs that are positioned relatively close together, the default or selected transmission power level setting may, for example, cause excessive distortion of the signal/transceiver saturation resulting in packet rejection and thus, rejection of the associated segment as a viable network segment. Advantageously, according to embodiments of the system 30, adjustment, e.g., reduction, of the power level setting in response to recognition of such problem can be employed to solve such problem.

As perhaps best shown in FIGS. 13 and 14, a message packet can be sent either specifically to refresh a segment element of the mesh network 32 to validate the segment as a viable message pathway, i.e., without payload, or to perform one of the various functions including those described below, concurrently validate the segment. As described above, the communications portion of a protocol message packet can include data elements describing a source node 101, the destination node, e.g., node 103, routing gateway information (RGI), e.g., node count, and up to the preselected number, e.g., 15, intermediate gateway nodes, e.g., nodes 105, 107, 109. The description of the source node 101 can include a selected routing source power level (RSPL), not shown, selected routing source radio frequency index (RSFI), routing source identification number (RSID), and routing source received signal strength indication (RSRSSI) describing the received signal strength of a transmission from an adjacent node, e.g., node 105. The description of the destination node 103 can include a selected routing destination power level (RDPL), not shown, selected routing destination radio frequency index (RDFI), routing destination identification number (RDID), and routing destination received signal strength indication (RDRSSI) describing the received signal strength of a transmission from an adjacent node, e.g., node 109. The description of each intermediate gateway node 105, 107, 109, can include a selected routing gateway power level (RGPL), not shown, selected routing gateway radio frequency index (RGFI), routing gateway identification number (RGID), and routing gateway received signal strength indications (RGRSSI) describing a receive frequency of an adjacent node. For example, a first received signal strength indication can describe the received signal strength of a transmission from a first adjacent node along the routing pathway, and a second received signal strength indication describing the received signal strength of a transmission from a second adjacent node along the routing pathway. As will be described in more detail below, the meter data collector program product 90 can maintain a database of the remote collection unit identification numbers and their active radio frequency indices, power levels, and received signal strengths based upon each successful communication.

The device hardware of each meter data collector 41, e.g., silicon integrated circuit such as Dallas Semiconductor DS2401/DS2411, can provide, for example, a 6-byte unique identification number. In such configuration, the least significant 4 bytes of the unique identification number are utilized to determine a selected routing source identification number. The least significant 1 byte of the selected routing source identification number determines the device default frequency index within the attached array of transmit and receive settings for a transceiver such as a Chipcon 1020 bi-directional transceiver as understood by those skilled in the art. For example, as illustrated in an exemplary embodiment described in U.S. patent application Ser. No. 10/779,429 titled “Automated Meter Reading System, Communication and Control Network for Automated Meter Reading, Meter Data Collector, and Associated Methods,” if the least significant byte of the selected routing source identification number were 0x00, then the corresponding receive frequency would be set to 909300000 hertz (Hz). If the least significant byte of the selected routing source identification number were 0x001, then the corresponding receive frequency would be set to 924200000 Hz. In this way, for example, 256 frequencies can be utilized and organized in a pseudorandom non-repeating manner.

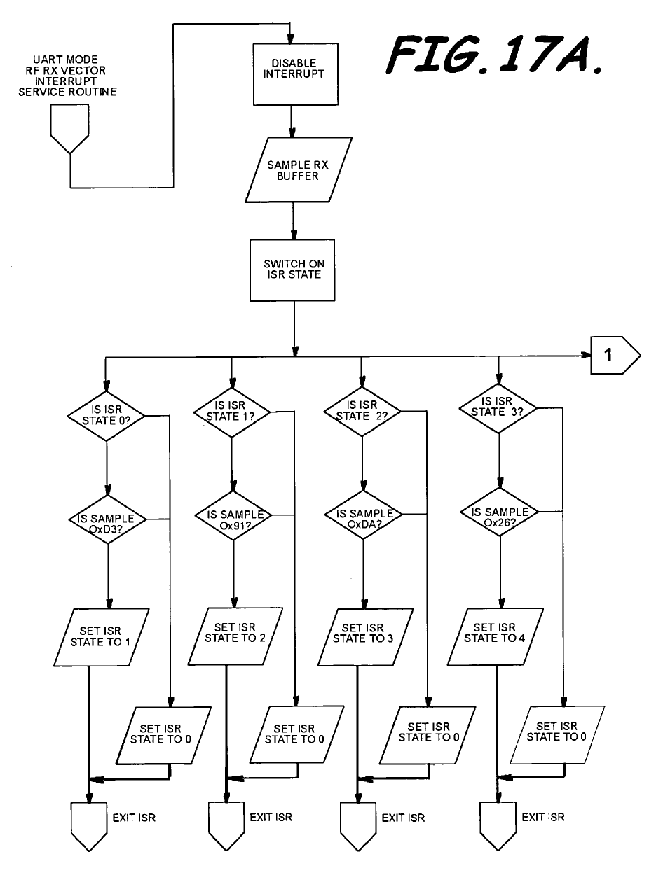

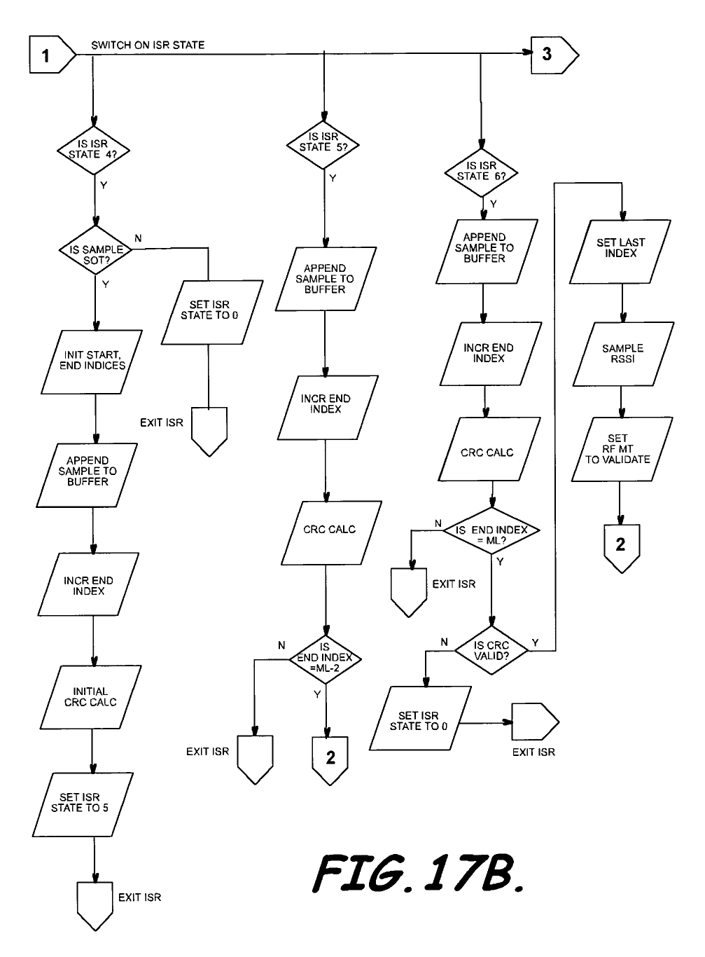

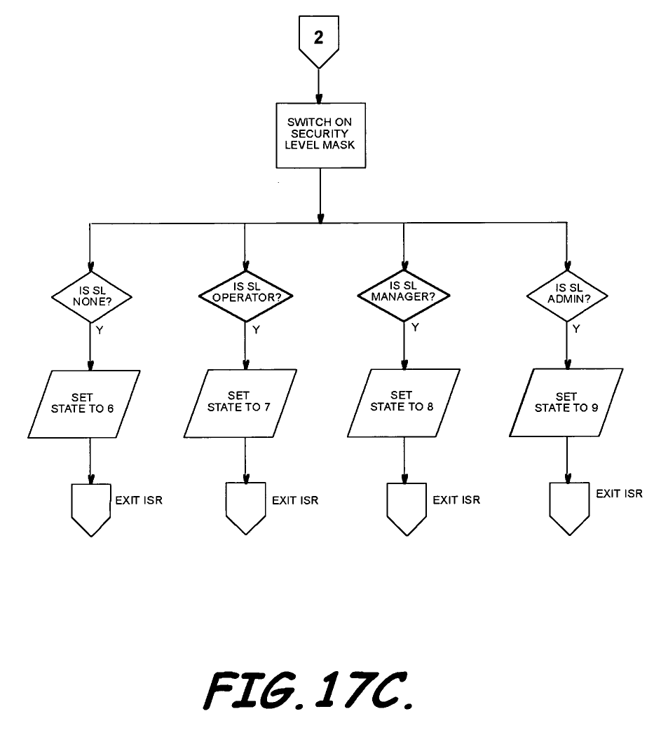

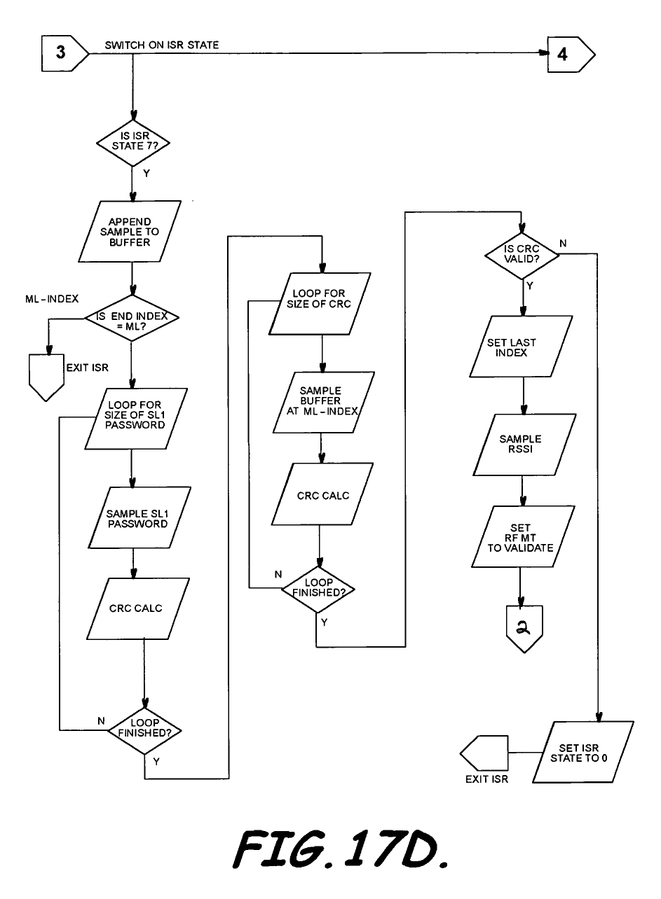

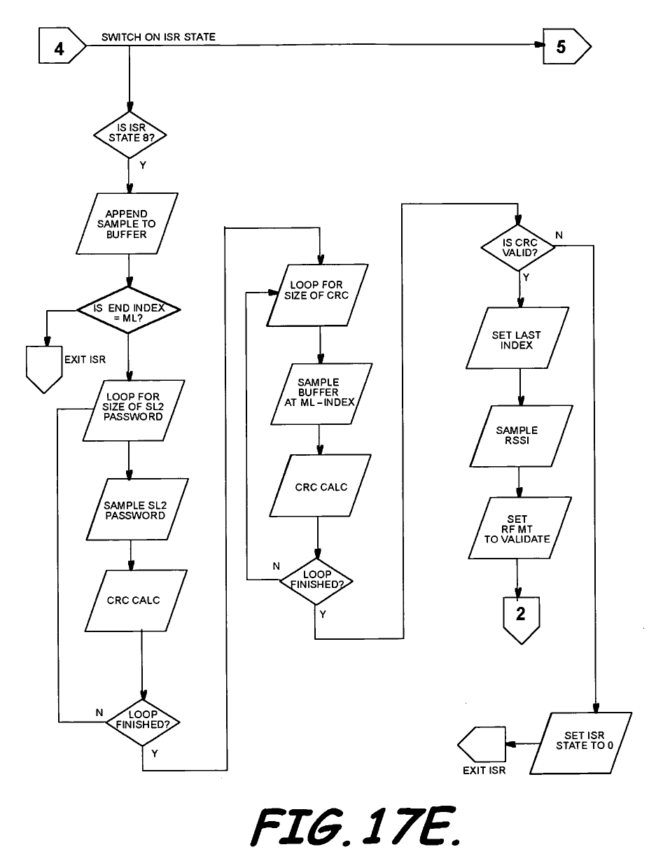

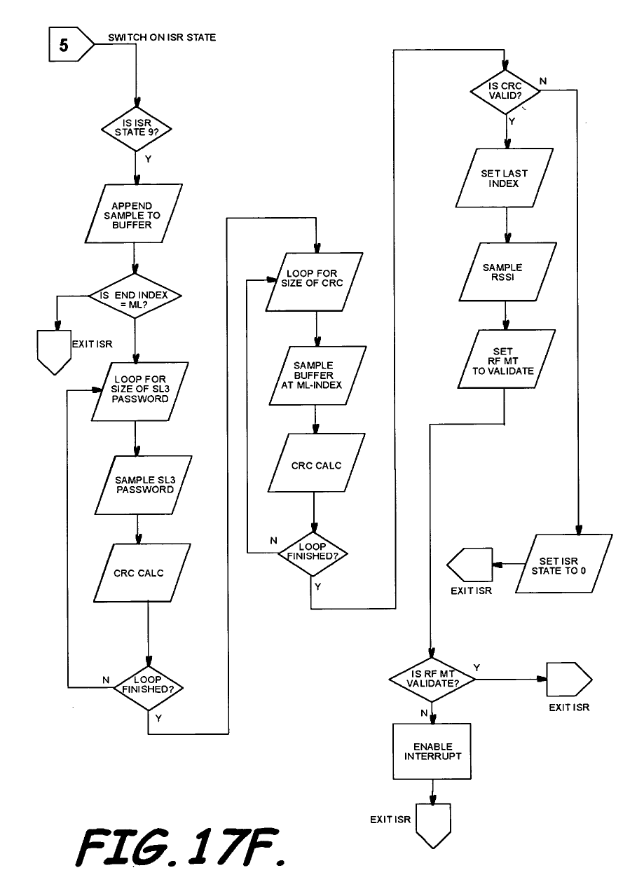

Upon arrival of the message packet to one of the nodes, the message packet can be synchronized and validated, for example, according to the process illustrated in FIGS. 17A-F, as will understood by those skilled in the art. Each node can use a meter data collector unit identification number to equal either the routing destination identification number or the first routing gateway identification number. The unit acknowledgment message validation can use the unit identification number to equal the routing destination identification number. Additional communication packet validation criteria include message sequence number, message type, and CRC calculations. Upon receipt of a valid message, the receiving node will increment/alter its radio frequency index and transmit an acknowledge packet to the received packet routing source identification number at the current radio frequency index. If the node was the intended destination, then after transmitting the acknowledgment packet the node can transmit the response at the incremented/altered radio frequency index. If the node was an intended receiver, but not the message destination (see, e.g., FIG. 5), after transmitting the acknowledgment packet, the node will forward the message utilizing the received packet first routing gateway frequency index. For example, the nodes configured to receive can shift frequencies in synchronization with the nodes configured to transmit as described above. The nodes, also for example, can use the same Chipcon 1020 bi-directional transceivers, or other transceivers as understood by those skilled in the art, and can be configured such that the receiver input bandwidth matches the hopping channel bandwidth of their corresponding transmitter.

Generally, the system 30 will refresh individual segments of the network 32 through normal utility meter data transmissions from each of the meter data collectors 41, typically sent every 15 minutes. According to a preferred embodiment of the present system, if a segment of the network 32 has not been refreshed for more than one hour, a “ping” can be transmitted in order to refresh one or more segments simultaneously. FIGS. 13 and 14 illustrate an exemplary refresh segments scenario including a source node 101, the destination node 103, and three intermediate gateway nodes 105, 107, 109, characterized by having an inbound route between the destination node 103 and the source node 101 a reverse of the outbound route between the source node 101 and the destination node 103, or vice versa. Advantageously, in order to perform such refresh process, the meter data collector program product 90 includes instructions that when executed by, for example, a processor of the host computer 61, processor of a field host data collector 51, 51′, or combination thereof, which when executed can perform the operations of assembling a protocol message packet to transmit data from a source node to a selected destination node according to a preselected outbound route, receive and analyze data in the protocol message packet provided by the meter data collectors 41 and transmitted according to a preselected inbound route, and determine an optimal transmission power level setting of one or more of the nodes along the outbound and inbound routes in response to the data analysis. The host computer 61 can function as the source node particularly when directly interfaced with a transceiver. Alternatively, the field host data collector 51, 51′, for example, can perform such function.

In operation, the protocol message packet can be assembled and then sent from a source node 101, e.g., host computer 61, to the destination node 103 along the outbound route. As part of construction of the protocol message packet, a power level setting for each node 101, 103, 105, 107, 109, along the outbound and inbound routes are assigned values. The protocol message packet is sent from the source node 101 to the first gateway node 105 at the power level and frequency specified by the routing source power level settings and routing source frequency indexes. If an optimal power level setting was previously determined by the system 30 through the meter data collector program product 90, that value can generally be used. When the power level value has not been previously determined such as where a node has been added to form a new potential segment of the network 32 or where a segment has been previously deemed unusable, a default power level setting, e.g., 28 dBm can be assigned. Note, according to an embodiment of the present invention, where a power level setting has been determined for a discrete radius between nodes defining offset rules, rather than begin at the initial default setting of 28 dBm for a new segment, if the radius of the new segment is the same as the discrete radius from which offset rules have been previously determined, such power level setting can instead be utilized.

If the transmission to the first gateway node 105 is successful, the first gateway node 105 can record the received signal strength of the transmission from the source node 101 and send an acknowledgment message to the source node 101. The communications portion of each an associated acknowledgement packet can include the routing source identification number identifying the meter data collector 41 transmitting the message, e.g., the first gateway node 105, routing source radio frequency index, routing destination identification number, and routing destination radio frequency index. Upon receipt of the acknowledgment message, the receiving node can increment the frequency which it is “listening” according to the preselected pseudorandom frequency index. If no acknowledgment message is received after a preselected timeout period, the node shifts frequency to the frequency which the node expects a response and awaits a timeout period, the length of which depends upon operation to be performed by the destination node or nodes.

Depending upon the message type, if a payload is included in the protocol message packet, data can be extracted from the payload, processed, and/or stored in the memory 45, and data can be extracted from memory 45 and uploaded to the payload, as will be described later. The first gateway node 105 can read the assigned power level and frequency index to be used to transmit to the second gateway node 107, set the power level and frequency, upload the routing source received signal strength indication to the protocol message packet, e.g., second received signal strength indication element for the first gateway node, increment the low nibble of the routing gateway information, and transmit the protocol message packet to the second gateway node 107 at the power level and frequency specified by the routing first gateway power level setting and routing first gateway source frequency index.

If the transmission to the second gateway node 107 is successful, the second gateway node 107 can record the received signal strength of the transmission from the first gateway node 105 and send an acknowledgment message to the first gateway node 105. The second gateway node 107 can read the assigned power level and frequency index to be used to transmit to the third gave way node 109, set the power level and frequency, upload the received signal strength indication to the protocol message packet, e.g., second received signal strength indication element for the second gateway node, increment the low nibble of the routing gateway information, and transmit the protocol message packet to the third gateway node 109 at the power level and frequency specified by the routing second gateway power level setting and routing second gateway frequency index.

If the transmission to the third gateway node 109 is successful, the third gateway node 109 can record the received signal strength of the transmission from the second gateway node 107 and send an acknowledgment message to the second gateway node 107. The third gateway node 109 can read the assigned power level and frequency index to be used to transmit to the destination node 103, set the power level and frequency, upload the received signal strength indication to the protocol message packet, e.g., second received signal strength indication element for the third gateway node, increment the low nibble of the routing gateway information, and transmit the protocol message packet to the destination node 103 at the power level and frequency specified by the routing third gateway power level setting and routing third gateway source frequency index.

If the transmission to the destination node 103 is successful, the destination node 103 can record the received signal strength of the transmission from the third gateway node 109 and send an acknowledgment message to the third gateway node 109. The destination node 103 can read the assigned power level and frequency index to be used to transmit to the third gateway node 109, set the power level and frequency, upload the received signal strength indication to the protocol message packet, e.g., received signal strength indication element for the destination node. According to an embodiment of the present invention having an inbound route between the destination node 103 and the source node 101 a reverse of the outbound route between the source node 101 and the destination node 103, such as that illustrated in FIGS. 13 and 14, the destination node 103 can reset the low nibble of the routing gateway information to zero and transmit the protocol message packet to the third gateway node 109 at the power level and frequency specified by the routing destination power level setting and routing destination source frequency index. According to an embodiment of the present invention, the frequency indicated in the routing destination source frequency index is the frequency the third gateway node 109 is calibrated to monitor, which is an increment of that at which the third gateway node 109 was previously calibrated to receive the message packet from the second gateway node 107.

If the transmission to the third gateway node 109 is successful, the third gateway node 109 can record the received signal strength of the transmission from the destination node 103 and send an acknowledgment message to the destination node 103. The third gateway node 109 can read the assigned power level and frequency index to be used to transmit to the second gateway node 107, set the power level and frequency, upload the received signal strength indication to the protocol message packet, e.g., first received signal strength indication element for the third gateway node, increment the low nibble of the routing gateway information, and transmit the protocol message packet to the second gateway node 107 at the power level and frequency specified by the routing third gateway power level setting and routing third gateway source frequency index.

If the transmission to the second gateway node 107 is successful, the second gateway node 107 can record the received signal strength of the transmission from the third gateway node 109 and send an acknowledgment message to the third gateway node 109. The second gateway node 107 can read the assigned power level and frequency index to be used to transmit to the first gateway node 105, set the power level and frequency, upload the received signal strength indication to the protocol message packet, e.g., first received signal strength indication element for the second gateway node, increment the low nibble of the routing gateway information, and transmit the protocol message packet to the first gateway node 105 at the power level and frequency specified by the routing second gateway power level setting and routing second gateway source frequency index.

If the transmission to the first gateway node 105 is successful, the first gateway node 105 can record the received signal strength of the transmission from the second gateway node 107 and send an acknowledgment message to the second gateway node 107. The first gateway node 105 can read the assigned power level and frequency index to be used to transmit to the source node 101, set the power level and frequency, upload the received signal strength indication to the protocol message packet, e.g., first received signal strength indication element for the first gateway node, increment the low nibble of the routing gateway information, and transmit the protocol message packet to the original source node 103 at the power level and frequency specified by the routing first gateway power level setting and routing first gateway source frequency index.

If the transmission to the original source node 103 is successful, the original source node 103 can record the received signal strength of the transmission from the first gateway node 105 and send an acknowledgment message to the first gateway node 105. The original source node 103 can upload the received signal strength indication to the protocol message packet, e.g., received signal strength indication element for the source (Host) node. Note, if the host computer 61 is also the source node, the uploading step can be omitted. Note also, according to another embodiment of the present invention, having an inbound route direct between the destination node 103 and the source node 101, such as that illustrated in FIG. 15, the destination node 103 can instead maintain the low nibble of the routing gateway information at its current value and transmit the protocol message packet to the original source node 101 at the power level and frequency specified by the routing destination power level setting and routing destination source frequency index.

According to both of the above illustrated embodiments, the host computer 61 receives the protocol message packet transmitted, and through the meter data collector program product 90, performs the operation of synchronizing and validating the message packet (see, e.g., FIGS. 17A and B). If the message packet is valid, the data in the message packet is analyzed. Specifically, the received signal strength indication for the original source and destination nodes 101, 103, and the received signal strength indications of each intermediate gateway node, e.g., nodes 105, 107, and 109, along with any payload data can be extracted for processing and/or analysis. Particularly, the received signal strengths can be used in determining an optimal transmission power level setting of one or more of the nodes along the outbound and inbound routes in response to the data analysis. For example, if the output power level of a first node transmitting to a second node along a particular segment is, e.g., 26 dBm and the received signal strength indication is 65, the next transmission or transmissions can be at consecutively lower power setting, such as, for example, 25 dBm or 20 dBm, until the strength changes, for example, from 65 to 66 or 70. Such changes in sensitivity can be analyzed and various calculations, as known to those skilled in the art, can be used to determine a threshold value that provides a substantially ideal signal at the determined distance between the nodes. Offset rules can also be established. According to embodiment of the present invention, such offset rules can be utilized for node pairs having a similar radius therebetween. Typically, such analysis can be completed in less than four iterations of transmitting message packets along each preselected segment. A default, for example, of ten iterations is generally sufficient.

If the message is not determined to be valid or if it never arrives, if the system 30 determines that a message packet should have been deliverable over a particular segment, the transmission power level of one or both of the nodes defining the segment can be adjusted either up or down in order to attempt to establish communications over the particular segment. If the nodes are located relatively close together, less than between 10-50 feet, for example, the transmission power level can be reduced in order to determine if a high power signal is saturating the receiver of the receiving segment node. Such saturation can typically cause clipping of the signal which will result in failure of the CRC check/invalidation of the message packet.

Additionally, according to an embodiment of the present invention, the segment need not be analyzed by transmitting the message packet along the same route or routes between source and destination nodes, but rather along routes that incorporate the preselected segment. For example, as shown in FIG. 16, the host computer 61 can transmit a second protocol message packet along a sequence route to either the same destination node 103 or different destination node 111 along a segment common with the first outbound or inbound sequence route (see FIG. 13) defining a common segment 115 having a first and a second common node, e.g. nodes 107, 109. One of the common nodes can be assigned a different power level setting in each of the first and the second protocol message packets to transmit the protocol message packets to the other common node. That is, the second common node, e.g., node 107, can be assigned, for example, a power level setting of 26 dB in the first protocol message packet and a power level setting of 25 dB in the second protocol message packet.

According to this illustrative example, if both of the protocol message packets are received and validated, the system 30, through use of the meter data collector program product 90, can compare the received signal strength indication of node 109 indicating the received signal strength of the first message packet transmitted from node 107 (e.g., 65 in this example) to the received signal strength indication of node 109 indicating the received signal strength of the second message packet transmitted from node 107 (e.g., 69 in this example). In response to the difference in signal strength, the lower power level setting, 25 dBm, can be assigned to node 107, at least initially, for transmission of operational data, and/or additional comparative iterations can be performed to further optimize the power level setting for node 107 and/or establishment of the offset rules for nodes having a similar radial separation. Note, according to this illustrative embodiment, if the resulting increase in signal strength results in an increase in distortion, the protocol message packet will likely not arrive or will be rejected. Failing validation, the signal strength will not be read and/or processed, and thus, the selected power level setting would generally be rejected. As identified above, if no message packet is returned or if the message packet fails validation, a preset number of attempts, e.g., ten, using different power level settings can be attempted prior to rejecting the segment as a valid segment within the network 32. For example, an object or fixture or high-power emitter may be causing an at least temporarily insurmountable disruption. Periodically, however, the segment can be reanalyzed as the disruption may eventually subside.

According to an embodiment of the system 30, each meter data collector 41 includes firmware stored in the memory 45 which includes instructions to manage operations of the respective meter data collector 41. In order to provide substantially real-time remote management of the meter data collectors 41, the host computer 61, through the meter data collector program product 90, can send a firmware update to one or more of the meter data collectors 41 carried in a payload data element protocol message packet. Accordingly, the microcontroller 43 of each destination meter data collector 41 can be adapted to receive, process, and store the firmware update. According to embodiment of the present invention, to further provide a uniform implementation of the firmware update, either the payload data carried by the payload data element or a portion of the meter data collector program product 90 stored in the memory 45 of the respective meter data collectors 41, for example, can include instructions, that when executed by the microcontroller 41 of each destination meter data collector 41, perform the operation of causing the microcontroller 43 to delay implementing the firmware update to allow a synchronized update of the firmware of the microcontrollers 43 of each of a subset of the meter data collectors 41.

According to an embodiment of the system 30, the host computer 61 can provide memory management instructions typically in the form of parameters to one or more of the meter data collectors 41 in the payload data element of a protocol message packet, described later. Advantageously, such feature allows the host computer 61 to manage data stored in individual memory addresses, read data from and write data to both volatile and nonvolatile memory elements, and exchange data between the volatile and nonvolatile memory elements. For example, the instructions can include those to fill characters, e.g., zeros, in a range of addresses, and write to/reading from the real-time clock memory, microcontroller flash memory, and ferroelectric random access memory, or other form of volatile and non-volatile memories utilized in the meter data collector 41. The instructions can also include those to transfer or copy between either of the non-volatile, microcontroller flash (volatile), and real-time clock memories.

As such, according to an embodiment of the present invention, the meter data collector program product 90 can include various functional modules such as, for example, a memory manager 121. The memory manager 121 is adapted to provide instructions in the payload data element which when executed by the microcontroller 43 of each destination meter data collector 41 can perform the operation of filling characters in a range of memory addresses, writing data included in the payload data element from the payload data element to volatile and nonvolatile memory, reading data from volatile and nonvolatile memory and loading the data in the payload data element, and transferring data between various memory elements of the meter data collector 41. The message type is a file message type which can be used to perform memory management on various types of memory including ferroelectric random access memory, real-time clock memory, microcontroller flash memory, copy, and fill memory types.

To perform the read function on either type of memory, the payload of the message packet should include, for example, file type, start position pointer, last position pointer, end position pointer. To perform the write function on the ferroelectric random access memory, real-time clock memory, or microcontroller flash memory, the payload of the message packet should include, for example, file type, start position pointer, last position pointer, end position pointer. To perform the copy function on either type of memory, the payload of the message packet should include, for example, file type, start position pointer and end position pointer for the source, and file type and start position pointer for the destination memory. To perform the fill function on either type of memory, the payload of the message packet should include, for example, file type, start position pointer, end position pointer, and character fill (value),e.g., all zeros to overwrite the identified range of memory.

According to an embodiment of the system 30, the host computer 61 can provide history data management instructions to one or more of the meter data collectors 41 in the payload data element of a protocol message packet to thereby manage the gathering of utility usage data from the meter data collectors 41. The payload data element carrying payload data element data can include a history pointer indicating a position in memory 45 of each destination meter data collector 41 of indicia of a starting point in the memory of unread history data to thereby prevent history data loss resulting from post transmission protocol message packet loss or corruption resulting in a mismatch between the last history data received by the host computer and the last history data transmitted by the destination meter data collector to thereby enhance history data integrity. For example, assume that a meter data collector 41 transmits utility usage data to the host computer 61 having a starting point in meter data collector memory 45 at memory location 0xABABABAB, but due to interference with one of the segments along the return route to the host computer 61, the data is lost or corrupted. Also assume by way of example that the next block of utility usage data for the respective meter data collector 41 is stored beginning at memory location 0xAEAEAEAE prior to the next to request for utility usage data. The meter data collector 41 would otherwise indicate the next block of utility usage data that needs to be provided to the host computer begins at memory location 0xAEAEAEAE. Accordingly, there can be situations where there is a mismatch between what utility usage data the host computer 61 believes was transmitted and what utility usage data the respective meter data collector 41 actually transmitted, resulting in lost utility usage data.

According to an embodiment of the present invention, system 30 can maintain a database, e.g., database 55, 65, including a next-read memory location for each selected meter data collector 41. The meter data collector program product 90 can include instructions executable to perform the operations of loading the next-read memory location into the payload data element of the protocol message packet prior to transmission to a destination node to thereby provide the destination node the next-read memory location for the history data stored in memory 45 of the selected destination meter data collector 41 to be sent to the host computer 61. Additionally, the firmware or portion of the meter data collector program product 90 stored in memory 45 of each respective meter data collector 41 can correspondingly include instructions executable to perform the operations of receiving the message packet, accessing the history pointer provided in the payload data element, reading the requested block of history data from the memory 45, and loading the read history data in the payload data element for transmission directly or indirectly to the host computer 61.

According to an embodiment of the present invention, the meter data collector program product 90 can include a history data integrity manager 123. The history data integrity manager 123 can include the instructions to perform the operations of accessing the database 65 to determine a next-read memory location for a selected meter data collector 41, loading the next-read memory location into the payload data element of the protocol message packet, and in response to return and validation of the protocol message packet having appended utility usage data, storing an indication of the next-read memory location of received utility usage data of the selected destination meter data collector 41 in the database 65. Note, the indication of the next-read memory location for each respective meter data collector 41 stored in the database 65 can include the actual next-read memory location, the last read memory location, or other indication known to those skilled in the art such as, for example, a time block where the number of memory address locations read from the respective selected meter data collector 41 is known and a time stamp or other consecutive indication of time is recorded in association with the utility usage data history.

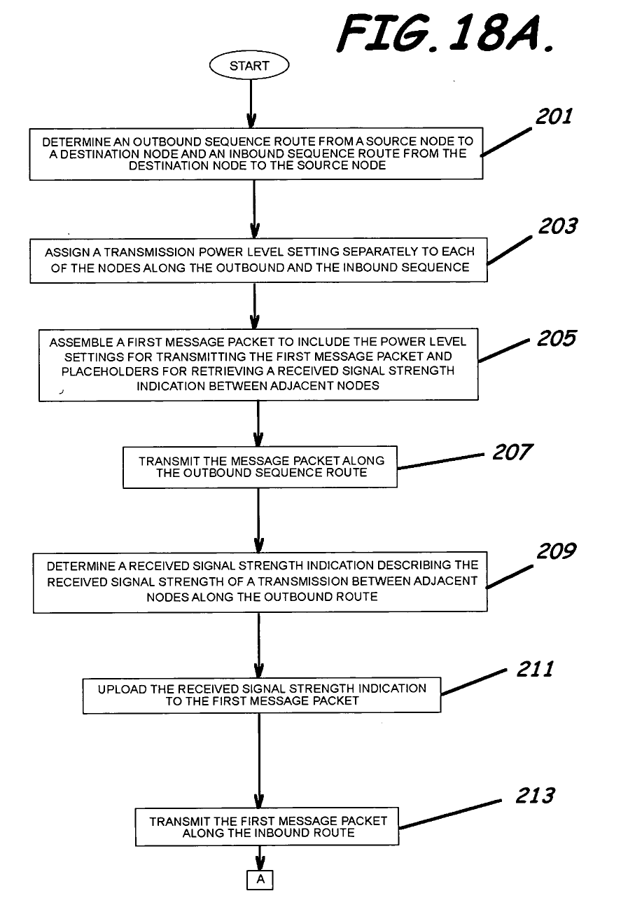

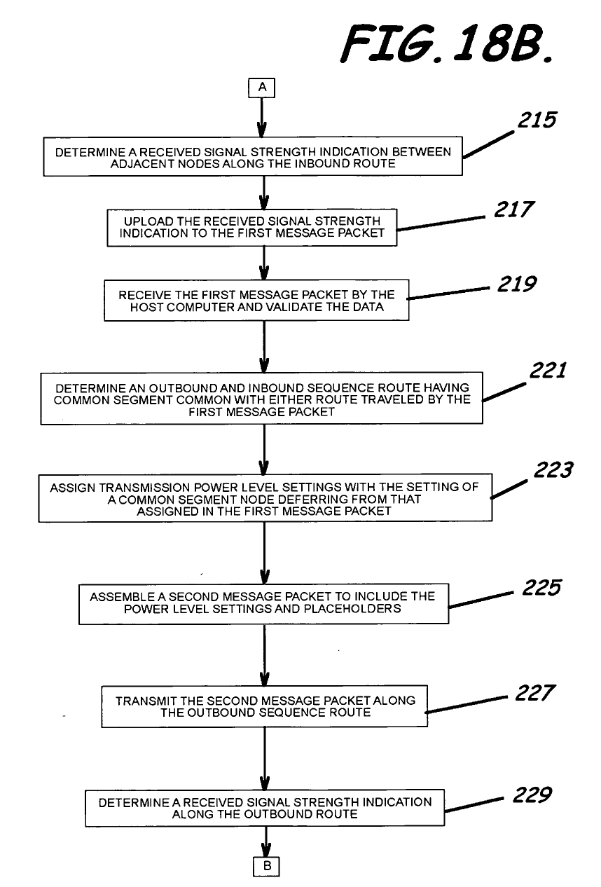

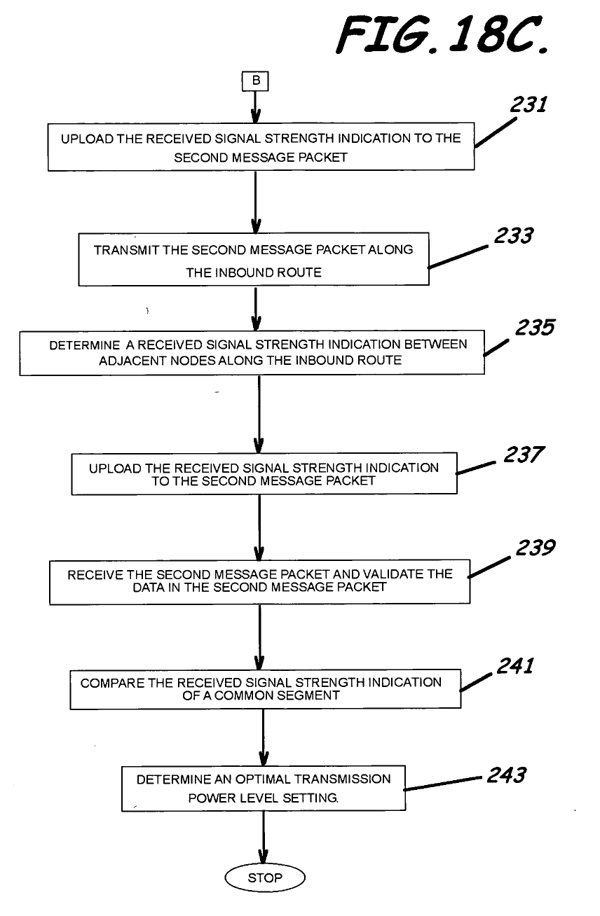

As shown in FIGS. 1-21, embodiments of the present invention include methods of collecting utility meter usage data. For example, as shown in FIGS. 18A-C, according to an embodiment of the present invention, a method of collecting utility meter usage data can include determining an outbound sequence route from a source node 101 to a destination node, e.g., node 103 (see, e.g., FIGS. 13 and 15) through one or more gateway nodes, e.g., nodes 105, 107, 109, and an inbound sequence route from the destination node 103 to the source node 101 (block 201), and assigning a transmission power level setting separately to each of the nodes along the outbound and the inbound sequence routes (block 203). Note, according to an embodiment of the method, the inbound sequence route can be directly to the source node, e.g., as shown in FIG. 15, rather than a reverse of the outbound sequence route, e.g., as shown in FIG. 13. Rather than individually polling each node within the expected transmission range of the source node 101, according to the preferred embodiment of the method, at least one of the outbound or inbound routes include intermediate gateway nodes, e.g., nodes 105, 107, 109. Advantageously, this can serve to reduce network congestion otherwise caused by the individual polling and allows for reaching nodes outside the range of the source node.

The method can also include assembling a first message packet to include the power level settings for transmitting the first message packet and to include placeholders for retrieving a received signal strength indication between adjacent nodes along the outbound and the inbound routes (block 205), and transmitting the first message packet along the outbound sequence route (block 207). The placeholders can initially be default received signal strength indication values such as, for example, all zeroes. As described previously, a control message type can be used to perform this function.

Upon receipt of the first message packet, each node along the outbound sequence route can determine and record a received signal strength indication describing the received signal strength of a transmission between the adjacent nodes along the route (block 209), and can add, copy, or otherwise upload the received signal strength indication to the first message packet (block 211). The steps can be accomplished for each node along the outbound sequence route, including at the destination node 103. The first message packet is then transmitted according to the inbound route (block 213) from the destination node 103 to the host computer 61 or other computer system, e.g., an intelligent field host data collector 51′. Similarly, each node along the inbound sequence route can determine and record a received signal strength indication describing the received signal strength of a transmission between adjacent nodes along the inbound route (block 215) and can upload the received signal strength indication to the first message packet (block 217). As the intermediate gateway nodes have two adjacent nodes, the message packet can accommodate received signal strength indications for each intermediate gateway node. Upon receipt of the first message packet, the first message packet and the data contained therein can be validated (block 219).

The method can also include determining another outbound sequence route from a source node 103 to either the same destination node 103 or a different destination node, e.g., node 111 through one or more gateway nodes, e.g., nodes 113, 107, 109 (see, e.g., FIG. 16) and another inbound sequence route from the selected destination node 111 to the source node 103 (block 221), and can include assigning a transmission power level setting separately to each of the nodes along the outbound and the inbound sequence routes (block 223). At least one of the outbound or inbound sequence routes have a segment common with either the outbound or the inbound sequence routes traveled by the first message packet, e.g., segment 115 between nodes 107, 109. Also, the power level setting of at least one of the nodes 107, 109, along the common segment 115 should be different from that assigned in the first message packet so that a power level setting-to-received signal strength analysis can be performed.

The method can also include assembling a second message packet to include the power level settings for transmitting the second message packet and to include placeholders for retrieving a received signal strength indication between adjacent nodes along the outbound and the inbound routes (block 225), and transmitting the second message packet along the outbound sequence route (block 227). Similar to that described with respect to the first message packet, upon receipt of the second message packet, each node along the outbound sequence route can determine and record a received signal strength indication describing the received signal strength of a transmission between the adjacent transmitting nodes (block 229), and can add, copy, or otherwise upload the received signal strength indication to the second message packet (block 231). The second message packet is then transmitted from the destination node to the host computer 61 according to the inbound route (block 233). Each node along the inbound sequence route can determine and record a received signal strength indication describing the received signal strength of a transmission between adjacent nodes along the inbound route (block 235) and can upload the received signal strength indication to the second message packet (block 237). As described with respect to the first message packet, upon receipt of the second message packet, the second message packet and the data contained therein can be validated (block 239).

The method can also include processing the received data from the validated message packets in response to the validation, comparing the received signal strength indication of one or more segments common to either the outbound or inbound routes traveled by the first message packet and the outbound or inbound routes traveled by the second message packet, e.g., segment 115 (block 241). The method can further include determining an optimal transmission power level setting of at least one of the nodes responsive to the data analysis (block 243).

According to this embodiment of the method, the optimal transmission power level setting determination can include determining a transmission power level setting of the adjacent node, e.g., node 107, that improves the received signal strength indication of the adjacent node, e.g., node 109, for the segment being refreshed, e.g., common segment 115. Multiple iterations of the assigning new power level settings and gathering of received signal strength indications further serve to enhance the optimization process. Additional message data packet transmission iterations having varying power level settings for selected network segments can be provided to further optimize the transmission power level setting for each selected network segment.

If either of the first or second message packets fails to return, additional message data packet transmission iterations along differing outbound and inbound sequence routes can be provided to attempt to determine a power level setting that will make the selected network segment viable. Correspondingly, according to an embodiment of the method, the optimal transmission power level setting determination can also or alternatively include determining a transmission power level setting of a node, e.g., node 107, that improves a message packet validation rate/statistics of message packets transmitted along a selected segment, e.g., common segment 115, and/or determining a reduced meter data collector transmission power level setting of one of the nodes, e.g., node 107, that results in either maintaining or improving the message packet validation rate of message packets transmitted along a path between the node 107 and an adjacent node, e.g., node 105, 109, 113.

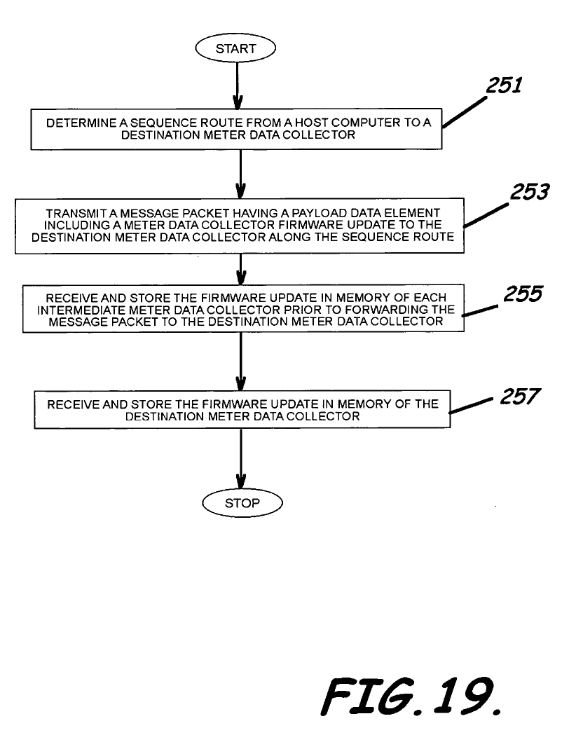

As shown in FIG. 19, according to an embodiment of the present invention, a method of collecting utility meter usage data can include providing remote firmware management of the meter data collectors 41. The method can include determining a sequence route, for example, from a host computer 61 to a destination meter data collector 41 generally through one or more intermediate meter data collectors 41 (block 251), and transmitting a message packet to the destination meter data collector 41 along the sequence route (block 253). According to this embodiment of the method, the message packet is a file type which contains a payload data element including a meter data collector firmware update. The method also can include receiving and storing the firmware update in memory 45 of each intermediate meter data collector 41 prior to forwarding the message packet to the destination meter data collector 41 (block 255). Advantageously, if the firmware update is to be made to each meter data collector 41 in the network 32 or a significant portion thereof, such step can significantly reduce the number of message packet transmissions. The method further includes receiving and storing the firmware update in memory 45 of the final destination meter data collector 41 (block 257).

According to an embodiment of the method, the method can include determining a plurality of separate sequence routes, for example, from the host computer 61 to a corresponding plurality of “final” destination meter data collectors 41, and transmitting the firmware update to the plurality of destination meter data collectors 41, as described above, to provide the firmware update to each meter data collector 41 in the network 32 or a significant portion thereof. The method can also include selectively delaying implementing the firmware update to allow a synchronized update of the firmware for each of the destination meter data collectors 41.

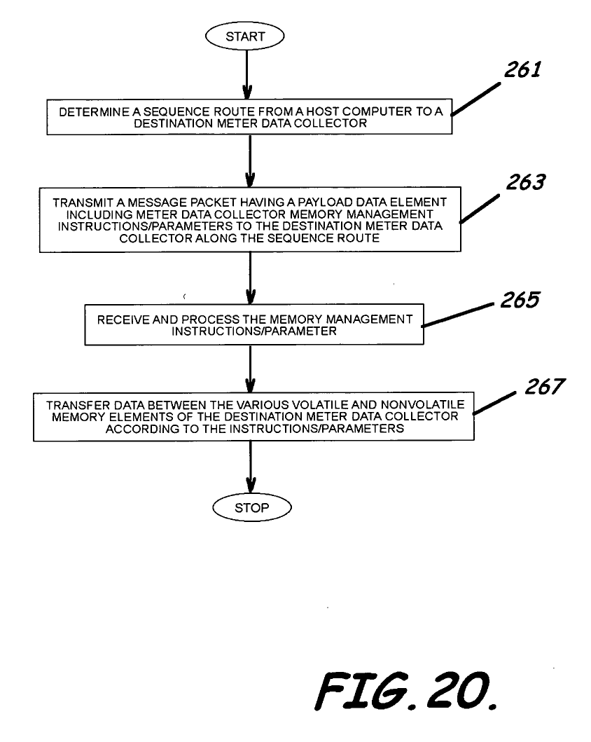

As perhaps best shown in FIG. 20, according to an embodiment of the present invention, a method of collecting utility meter usage data can include providing remote memory management of the meter data collectors 41. Similar to the steps described with respect to remote firmware management, this method can include determining a sequence route, for example, from a host computer 61 to a destination meter data collector 41 generally through one or more intermediate meter data collectors 41 (block 261), and transmitting a message packet to the destination meter data collector 41 along the sequence route (block 263). According to this embodiment of the method, the message packet is also a file type which contains a payload data element including meter data collector memory management instructions/parameters. The method also can include receiving and processing the memory management instructions/parameters (block 265), and transferring data between the various volatile and nonvolatile memory elements of the destination meter data collector 41 according to the instructions/parameters (block 267).

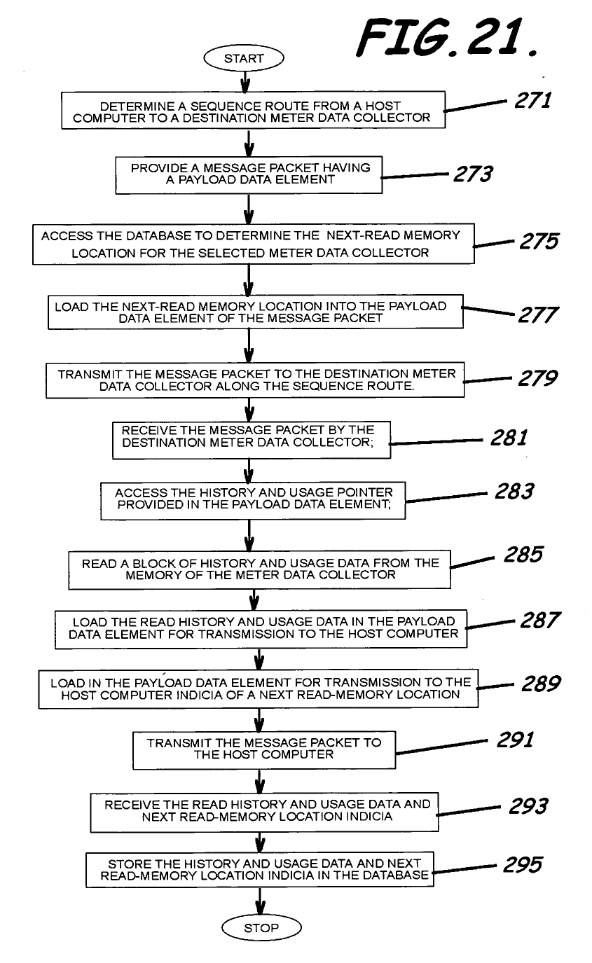

As perhaps best shown in FIG. 21, embodiments of the present invention provide a method of collecting utility meter usage data which can enhance history and usage data integrity for data remotely retrieved from a plurality of meter data collectors 41 by preventing history and usage data loss resulting from post transmission message packet loss or corruption of a message packet carrying history and usage data. Such history and usage data loss can result in a mismatch between the last history and usage data received by the host computer 61 and the last history and usage data transmitted by a destination meter data collector 41. That is, such loss can result in a mismatch between what the host computer system storing such history and usage data would otherwise indicate as the last history and usage data received from a destination meter data collector 41 and what the microcontroller 43 of the meter data collector 41 would otherwise indicate as the last history and usage data sent to the host computer system.

Accordingly, such a method can include determining a sequence route from a computer system, e.g., a host computer 61, to a selected destination meter data collector 41, for example, through one or more intermediate meter data collectors 41 (block 271), and can include assembling or otherwise providing a message packet having a payload data element adapted to carry a history and usage pointer, e.g., four byte pointer, providing indicia of a starting point in memory 45 of the selected meter data collector 41 of unread history and usage data (block 273). The method can also include accessing a database 65 to determine the next-read memory location for the selected meter data collector 41 (block 275), loading the next-read memory location into the payload data element of the message packet (block 277), and transmitting the message packet to the selected destination meter data collector 41 along the sequence route (block 279).

The method can further include receiving the message packet by the selected meter data collector 41 (block 281), accessing the history and usage pointer provided in the payload data element (block 283), reading a block of history and usage data from the memory 45 of the meter data collector 41 in response to the history and usage pointer (block 285), loading the read history and usage data in the payload data element for transmission to the host computer 61 (block 287), loading in the payload data element for transmission to the host computer 61 indicia of a next-read memory location indicating the next position in the memory 45 of the meter data collector 41 to retrieve history and usage data (block 289), and transmitting the read history and usage data to the host computer 61 (block 291). The method can still further include receiving and otherwise extracting the read history and usage data from the payload data element of the message packet (block 293), and storing the history and usage data and the indicia of the next-read memory location in the database 65 (block 295). This next-read memory location can be used in the next iteration of requesting history and usage data from the respective meter data collector 41 to ensure no gaps in the history and usage data exist.

According to another embodiment of the method, rather than the host system initiating the request for history and usage data, the history and usage data can be automatically sent by the meter data collector 41 along with indicia of the currently-read memory location and the indicia of a next-read memory location. Advantageously, this can also allow the host system to verify that the provided history and usage data was read from the expected memory location in the meter data collector 41.

It is important to note that while embodiments of the present invention have been described in the context of a fully functional system, those skilled in the art will appreciate that the mechanism of the present invention and/or aspects thereof are capable of being distributed in the form of a computer readable medium of instructions in a variety of forms for execution on a processor, processors, or the like, and that the present invention applies equally regardless of the particular type of signal bearing media used to actually carry out the distribution. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, and other newer types of memories, and transmission type media such as digital and analog communication links. Note, the instructions can be divided between multiple physical forms of medium for processing by components within a system having different functions such as, for example, the host computer 61, the field host collectors 51, 51′, remote computer 53, collectors 34, 35, and the meter data collectors 41. Also, each of the different components within the system can receive and process a different subset of the instructions.

As shown in FIGS. 1-21, embodiments of the present invention also include a computer readable medium that is readable by a computer, controller, microcontroller, or processor collectively labeled as either a “processor” or a “computer” to collect utility meter usage data. For example, in an embodiment of the present invention, the computer readable medium includes a set of instructions, that when executed by the computer, e.g., a host computer 61 or other computer system, cause the computer to perform the operation of determining an outbound sequence route from a host computer system to a destination meter data collector 41 and an inbound sequence route from the destination meter data collector 41. One or both of the routes can include one or more intermediate gateway meter data collectors 41 in order to allow simultaneous polling multiple meter data collectors 41. Advantageously, polling multiple meter data collectors 41 in a single message packet transmission can provide a significant reduction in network congestion over that of performing separate single-level polling of individual segments.

The instructions can also include those to perform the operations of assigning a transmission power level setting separately to each of the meter data collectors 41 along the outbound and the inbound sequence routes, assembling a message packet to include the power level settings for transmitting the message packet and to include placeholders for retrieving a received signal strength indication between adjacent meter data collectors 41 describing the received signal strength of the message packet received from an adjacent meter data collector or collectors 41 along the outbound and the inbound routes, and sending the message packet along the outbound sequence route. The instructions can also include those to perform the operations of receiving the message packet, validating the message packet, and analyzing the received signal strength indications for one or more of the meter data collector 41.

The instructions associated with the individual collectors along the outbound and inbound sequence routes, e.g., meter data collectors 41, can correspondingly include those to perform the operations of determining and recording a received signal strength indication describing the received signal strength of a transmission between the adjacent transmitting meter data collectors 41, and adding, copying, or otherwise uploading the received signal strength indication to the message packet. These instructions can also include those to perform the operations of reading the received power level and transmission frequency, setting the transmission power level and frequency, and forwarding or otherwise sending the message packet along the preselected route.

According to an embodiment of the present invention, the operations of determining outbound and inbound sequence routes, assigning power level settings, assembling a message packet, sending the message packet, receiving the message packet, validating the message packet, and analyzing received signal strength indications, can be iteratively performed using a different power level setting for at least one of the meter data collectors 41 along either the outbound or inbound routes so that a common segment can be “refreshed” and analyzed to determine the optimum power level setting for transmitting over that common segment. According to this embodiment, the outbound and inbound routes can be different from those of each prior iteration except for the common segment being analyzed. As such, the instructions can include those to perform the operations of processing the received data from the validated message packets in response to the validation, comparing the received signal strength indication of one or more common segments, and determining an optimal transmission power level setting of at least one of the nodes in response to the data analysis.

According to the preferred embodiment of the present invention, a power level setting is considered an improvement when the received signal strength indication of one of the meter data collectors 41 along the common segment provided in the validated message packet increases due to the change in a transmission power level setting for the other meter data collector 41 of the common segment or if a decrease in the power level setting of the other meter data collector 41 results in either an increase or at least an insubstantial decrease in received signal strength indication. Note, if a resulting increase in signal strength results in an increase in distortion, the message packet will likely not arrive or will be rejected. Failing validation, the signal strength should not be read. Additional power level setting iterations can be performed until reaching a selected limit, e.g., ten iterations. Accordingly, according to an embodiment of the present invention, a power level setting is considered an improvement when transmission of the message packet at a particular transmission power level setting improves the message packet validation rate of a message packet or packets transmitted along the common segment, or at least does not substantially reduce the message packet validation rate of the a message packet or packets transmitted along the common segment and the second transmission power level setting is less than that of the previous iteration or iterations.

The instructions can also include those to perform the operation of selecting an alternative route bypassing at least one meter data collector 41 of the common segment if the common segment fails to provide for transport of valid message packets or if the associated meter data collectors 41 continually indicate a received signal strength indication weaker than that available through use of alternative routing. The instructions can further include those to perform the operations of determining an optimum power level setting for each of a plurality of segments providing alternative routing to a destination meter data collector 41, comparing the received signal strength indications corresponding to the optimum power level setting for each segment, and determining a preferred polling sequence route responsive to the comparison. Note, if the received signal strengths are the same for alternate segments, the algorithm according to the preferred embodiment of the present invention can flip-flop between segments during successive route selection processes.

As will be recognized by those skilled in the art, part of collecting utility meter usage data can include efficient firmware management. Correspondingly, according to an embodiment of the present invention, the computer readable medium can include a set of instructions that, when executed by a computer, e.g., host computer 61 or other computer systems, cause the computer to perform the operations of determining a sequence route from a host computer system to a destination meter data collector 41 through, for example, one or more intermediate meter data collectors 41, assembling a message packet having a payload data element for carrying a meter data collector firmware update, and sending the message packet along with the firmware update to the destination meter data collector 41 along the sequence route. Accordingly, the instructions, particularly those associated with the meter data collectors 41, can include those to perform the operations of receiving and storing the firmware update in memory 45 of each intermediate meter data collector 41 prior to forwarding the message packet to the destination meter data collector 41, and receiving and storing the firmware update in memory 45 of the destination meter data collector 41.

The computer readable medium, according to an embodiment of the present invention, can further include instructions to perform the operations of determining a plurality of separate sequence routes from the host computer system to a corresponding plurality of destination meter data collectors 41 and sending the firmware update to the plurality of destination meter data collectors 41. The instructions, particularly those associated with the meter data collectors 41, can further include those to perform the operation of delaying implementing the firmware update to allow a synchronized update of the firmware for each of the plurality of destination meter data collectors 41.

As will also be recognized by those skilled in the art, part of collecting utility meter usage data can also include efficient memory management. Correspondingly, according to an embodiment of the present invention, the computer readable medium can include a set of instructions, that when executed by a computer, e.g., host computer 61 or other computer system, cause the computer to perform the operations of determining a sequence route from a host computer system to a destination meter data collector, assembling a message packet having a payload data element for carrying meter data collector memory management parameters, and sending the message packet along with the memory management parameters to the destination meter data collector 41 along the sequence route. The instructions, particularly those associated with the meter data collectors 41, can further include those to perform the operation of receiving the memory management parameters, and transferring data between the volatile and nonvolatile memory elements of the destination meter data collector 41 in response the memory management parameters.

Part of collecting utility meter usage data also can include ensuring history and usage data integrity. Correspondingly, according to an embodiment of the present invention, a computer readable medium can include a set of instructions, that when executed by a computer, e.g., host computer 61 or other computer system, cause the computer to perform the operations of determining a sequence route from a host computer system to a destination meter data collector 41, providing a message packet having a payload data element, accessing a database, e.g., database 65, to determine the next-read memory location for the selected meter data collector 41, loading an, e.g., four byte, history and usage pointer in the payload data element, and sending the message packet to the destination meter data collector along the sequence route. Advantageously, the history and usage pointer provides indicia of a starting point in memory 45 of the destination meter data collector 41 of the next block of unread history and usage data defining the next-read memory location. This starting point can be, for example, either a last read memory location or a next read memory location.

The instructions, particularly those associated with the meter data collectors 41, can include those to perform the operations of sensing or otherwise receiving meter usage data from one or more utility meters, collecting and storing the history and usage data in memory 45 of the respective destination meter data collector 41, receiving the message packet by the destination meter data collector 41, accessing the history and usage pointer provided in the payload data element, reading a block of history and usage data from the memory of the meter data collector responsive to the history and usage pointer, loading the read history and usage data in the payload data element for transmission to the host computer system, loading indicia of a next read-memory location in the payload data element for transmission to the host computer system, and sending or otherwise forwarding the message packet to the host computer system. The indicia of a next read-memory location can indicate the position in the memory 45 of the destination meter data collector 41 to retrieve the next block of history and usage data during the next history and usage data retrieval iteration.

Accordingly, particularly those instructions associated with a host computer system, can include those to perform the operations of receiving the read history and usage data and next-read memory location indicia, and storing the history and usage data and next-read memory location indicia in the database 65 for later retrieval for use with retrieving the next block of history and usage data not yet requested or received by the host computer system. That is, rather than merely have the meter data collectors 41, themselves, store the indicia of the location in memory 45 of history and usage data not yet sent to the host computer system, the host computer system can also or additionally advantageously store such indicia for each of the meter data collectors 41 to thereby prevent data integrity failure due to an in route loss or corruption of the history and usage data during transit between the meter data collector 41 and the host computer system.

Embodiments of the present intention also include a computer memory element containing, stored in signal bearing media, a database, e.g., database 55, 65, containing, in computer readable format, data indicating utility service history and usage provided by each of a plurality of meter data collectors 41 forming a network, e.g., network 32, and data indicating for each of the plurality of meter data collectors 41 indicia of a starting point in memory 45 of the next block of unread history and usage data defining a next-read memory location. Note, indicia of a starting point in memory 45 can include the actual memory address of the starting point or the ending point of a prior read block of memory where the starting point of the unread (non-transferred) block of memory is positioned consecutively thereafter, such as, for example, where a circular buffer is used, or alternatively, where the starting point of the unread block of memory is offset from the ending point of the prior read block of memory according to an algorithm known to the host computer system.

In the drawings and specification, there have been disclosed a typical preferred embodiment of the invention, and although specific terms are employed, the terms are used in a descriptive sense only and not for purposes of limitation, the scope of the invention being set forth in the following claims. The invention has been described in considerable detail with specific reference to these illustrated embodiments. It will be apparent, however, that various modifications and changes can be made within the spirit and scope of the invention as described in the foregoing specification.

That claimed is:

1. An automated meter reading network system comprising:
a plurality of utility meters;
a plurality of sensors each interfaced with and positioned adjacent one of the plurality of utility meters to sense utility usage data therefrom;
a plurality of meter data collectors each defining a node and each associated with a separate one of the plurality of utility meters and positioned spaced apart from and in cross-radio frequency communication with a subset of the other ones of the plurality of meter data collectors to thereby define a mesh communication network, each meter data collector including a microcontroller in communication with at least one of the plurality of sensors to collect the utility usage data, memory positioned to store the collected utility usage data, and a radio frequency telemetry module having a transmission power level setting and positioned to transmit the utility usage data;
a host computer positioned remote from and in communication with the plurality of meter data collectors to receive the utility usage data and having a processor to process the utility usage data and memory in communication with the processor to store the utility usage data; and
meter data collector program product at least partially stored in the memory of the host computer and comprising instructions that when executed by the host computer perform the operations of assembling a protocol message packet to transmit data from the host computer to a selected one of the plurality of nodes defining a destination node according to a first preselected route, receiving and analyzing data in the protocol message packet transmitted to the host computer according to a second preselected route, and determining an optimal transmission power level setting of at least one of the plurality of nodes responsive to the data analysis, the protocol message packet having data elements describing a source node, the destination node, and a plurality of intermediate gateway nodes, the descriptions of the source node and the destination node each including a selected transmission power level setting, a selected receive frequency index, a node identification, and a received signal strength indication describing the received signal strength of a transmission from an adjacent node, and the descriptions of each of the plurality of intermediate gateway nodes including a selected transmission power level setting, a selected receive frequency index describing a receive frequency of an adjacent node, a node identification, a first received signal strength indication describing the received signal strength of a transmission from a first adjacent node, and a second received signal strength indication describing the received signal strength of a transmission from a first adjacent node.

2. A system as defined in claim 1, wherein when the protocol message packet is received by the destination node the protocol message packet includes a first determined received signal strength indication data value at each of the plurality of gateway nodes identified in the protocol message packet received from each of the plurality of intermediate gateway nodes.

3. A system as defined in claim 1, wherein the second preselected route is a reverse of the first preselected route, and wherein when the protocol message packet is returned to the source node the protocol message packet includes a determined received signal strength indication data value at each of the source node and the destination node received from the source node and the destination node and a first and a second determined received signal strength indication at each of the plurality of gateway nodes identified in the protocol message packet received from each of the plurality of intermediate gateway nodes.

4. A system as defined in claim 1, wherein the second preselected route is a single segment between the destination node and the source node without intermediate gateway nodes defining a destination node-to-source node segment, wherein the protocol message packet is a refresh segments protocol message packet adapted to retrieve signal strength data for at least one segment along each of the first and second preselected routes, the first and the second preselected routes selected so that a plurality of segments can be refreshed in a single refresh segments protocol message packet transmission circuit to thereby reduce network congestion due to single-segment polling.

5. A system as defined in claim 1, wherein the transmission power level setting for each of the nodes is a respective first transmission power level setting for each node, wherein the protocol message packet is a first protocol message packet, wherein the received signal strength between each adjacent node is a respective first received signal strength between each adjacent node, and wherein the meter data collector program product includes instructions to perform the operations of:
transmitting a second protocol message packet along a third sequence route having a segment common with the first sequence route or the second sequence route defining a common segment having a first and a second common node, the second common node assigned a second transmission power level setting lower than the first transmission power level setting to transmit the second protocol message packet to the first common node;
receiving and validating the first and the second protocol message packets;
comparing a second received signal strength for the first common node along the common segment with an associated first received signal strength responsive to receiving and validating the first and the second protocol message packets; and
assigning the second power level setting to the second common node responsive to the comparison when the respective second received signal strength is greater than or equal to the respective first received signal strength for the common node.

6. A system as defined in claim 1, wherein each meter data collector includes firmware stored in the memory, wherein the protocol message packet further includes a payload data element, and wherein the payload data element data when sent by the host computer includes a firmware update, and wherein the microcontroller of the destination meter data collector is adapted to receive and store the firmware update to thereby provide remote firmware management.

7. A system as defined in claim 6, wherein the payload data includes instructions that when executed by the microcontroller of the destination meter data collector perform the operation of causing the microcontroller to delay implementing the firmware update to allow a synchronized update of the firmware of the microcontrollers of each of a subset of the plurality of meter data collectors.

8. A system as defined in claim 1, wherein the memory of each meter data collector includes volatile and nonvolatile memory elements, wherein the protocol message packet further includes a payload data element, and wherein the payload data element data when sent by the host computer includes memory management instructions, and wherein the microcontroller of each meter data collector is adapted to receive and process the memory management instructions to perform the operation of transferring data between the volatile and nonvolatile memory elements to thereby provide remote memory management.

9. A system as defined in claim 1,
wherein the protocol message packet further includes a payload data element carrying payload data element data including a history pointer indicating a position in memory of a destination meter data collector of indicia of a starting point in the memory of unread history data to thereby prevent history data loss resulting from post transmission protocol message packet loss or corruption resulting in a mismatch between the last history data received by the host computer and the last history data transmitted by the destination meter data collector to thereby enhance history data integrity; and
wherein the destination meter data collector includes firmware adapted to perform the operation of accessing the history pointer provided in the payload data element, reading a block of history data from the memory of the meter data collector, and loading the read history data in the payload data element for transmission to the host computer.

10. A system as defined in claim 1,
wherein the system further comprises a database accessible to the processor of the host computer and having database records including history data for each of the plurality of utility meters and database records including indicia of a next-read memory location for each of the plurality of meter data collectors; and
wherein the meter data collector program product further comprises instructions to perform the operations of selecting one of the plurality of meter data collectors defining the destination node, accessing the database to determine the next-read memory location for the selected meter data collector, and loading the next-read memory location into the payload data element of the protocol message packet to thereby provide the destination node the next-read memory location for the history data stored in memory of the destination node to be sent to the host computer for storage in the database.

11. An automated meter reading network system comprising:
a plurality of utility meters;
a plurality of meter data collectors each defining a node and each associated with one of the plurality of utility meters and positioned spaced apart from and in cross-radio frequency communication with a subset of the other ones of the plurality of meter data collectors, each meter data collector including a microcontroller adapted to collect the utility usage data, memory to store the collected utility usage data, and a telemetry module to transmit the utility usage data;
a host computer positioned remote from and in communication with the plurality of meter data collectors to receive the utility usage data and having a processor to process the utility usage data and memory in communication with the processor to store the utility usage data; and
meter data collector program product at least partially stored in the memory of the host computer and comprising instructions that when executed by the host computer perform the operations of:
assembling an outbound message packet to transmit data from the host computer to at least one of the plurality nodes,
receiving and analyzing data appended to an inbound message packet transmitted from the at least one of the plurality of nodes to the host computer responsive to the outbound message packet, and
determining an optimal transmission power level setting of at least one of the plurality of nodes responsive to the data analysis.

12. A system as defined in claim 11,
wherein the data appended to the inbound message packet when received by the host computer includes a determined receive signal strength indication describing the received signal strength of a transmission from a node adjacent the at least one of the plurality of nodes defining an adjacent node;
wherein the operation of receiving data includes the operation of validating the inbound message packet;
wherein the operation of analyzing data includes the operation of processing the received data from the validated inbound message packet responsive to the validation; and
wherein the operation of determining an optimal transmission power level setting includes the operation of at least one of the following:
determining a transmission power level setting of the adjacent node that improves a message packet validation rate of inbound message packets transmitted along the path between the at least one of the plurality of nodes and the adjacent node, and
determining a reduced meter data collector transmission power level setting of the adjacent node that maintains or improves the message packet validation rate of inbound message packets transmitted along the path between the at least one of the plurality of notes and the adjacent node.

13. A system as defined in claim 11, wherein the message packets include data elements describing a source node, a destination node, and an intermediate gateway node, the descriptions of the source node and the destination node each including a selected transmission power level setting, a selected receive frequency index, a node identification, and a received signal strength indication, and the descriptions of each of the plurality of intermediate gateway nodes including a selected transmission power level setting, a selected receive frequency index, a node identification, a first received signal strength indication, and a second received signal strength indication.

14. A system as defined in claim 13, wherein the outbound message packet is transmitted to the destination node via the source node over a first preselected route, wherein the inbound message packet is a version of the outbound message packet transmitted back to the host computer via a second preselected route, and wherein when the inbound message packet is processed by the source node the inbound message packet includes a determined received signal strength indication data value at each of the source node and the destination node received from the source node and the destination node and a first and a second determined received signal strength indication at each of the plurality of gateway nodes identified in the inbound message packet received from each of the plurality of intermediate gateway nodes.

15. A system as defined in claim 14, wherein the second preselected route is a single segment between the destination node and the source node without intermediate gateway nodes defining a destination node-to-source node segment, wherein the outbound and inbound message packets are a refresh segments protocol message packet adapted to retrieve signal strength data for at least one segment along each of the first and second preselected routes, the first and the second preselected routes selected so that a plurality of segments can be refreshed in a single refresh segments message packet transmission circuit to thereby reduce network congestion due to single-segment polling.

16. A system as defined in claim 11, wherein each meter data collector includes firmware stored in the memory, wherein the outbound message packet further includes a payload data element, and wherein the payload data element data when sent by the host computer includes a firmware update, and wherein the microcontroller of the destination meter data collector is adapted to receive and store the firmware update to thereby provide remote firmware management.

17. A system as defined in claim 11, wherein the memory of each meter data collector includes microcontroller flash memory, microcontroller nonvolatile memory, and real-time clock memory, wherein the outbound message packet includes a payload data element, and wherein the payload data element data when sent by the host computer includes memory management instructions, and wherein the microcontroller of each meter data collector is adapted to receive and process the memory management instructions to perform the operation of transferring data between at least one pair of the microcontroller flash memory, microcontroller nonvolatile memory, and real-time clock memory, to thereby provide remote memory management.

18. A system as defined in claim 11, wherein the outbound message packet further includes a payload data element carrying payload data element data including a history pointer indicating a position in memory of a destination meter data collector of indicia of a starting point in the memory of unread history and usage data to thereby prevent history and usage data loss resulting from post transmission inbound message packet loss or corruption resulting in a mismatch between the last history and usage data received by the host computer and the last history and usage data transmitted by the destination meter data collector to thereby enhance history and usage data integrity.

19. A system as defined in claim 18, wherein the inbound message packet is a version of the outbound message packet transmitted back to the host computer, and wherein the destination meter data collector includes firmware adapted to perform the operation of accessing the history pointer provided in the payload data element, reading a block of history and usage data from the memory of the meter data collector, and loading the read history and usage data in the payload data element for transmission to the host computer.

20. A system as defined in claim 11,
wherein the system further comprises a database accessible to the processor of the host computer and having database records including history and usage data for each of the plurality of utility meters and database records including indicia of a next-read memory location for each of the plurality of meter data collectors;
wherein the outbound message packet further includes a payload data element; and
wherein the meter data collector program product further comprises instructions to perform the operations of selecting one of the plurality of meter data collectors defining the destination node, accessing the database to determine the next-read memory location for the selected meter data collector, and loading the next-read memory location into the payload data element of the outbound message packet to thereby provide the destination node the next-read memory location for the history and usage data stored in memory of the destination node to be sent to the host computer for storage in the database.

21. A method of collecting utility meter usage data, the method comprising the steps of:
assembling a message packet to transmit data from a host computer to a selected one of a plurality of nodes defining a destination node according to a first preselected route to the destination node along at least one other of the plurality of nodes;
receiving and analyzing data in the message packet transmitted to the host computer according to a second preselected route from the destination node; and
determining an optimal transmission power level setting of at least one of the plurality of nodes responsive to the data analysis.

22. A method as defined in claim 21,
wherein the method further comprises the steps of determining a received signal strength indication describing the received signal strength of a transmission between adjacent nodes along the first or the second preselected routes for at least one pair of adjacent nodes of the plurality of nodes and uploading the received signal strength indication to the message packet;
wherein the step of receiving the data includes the step of validating the data in the message packet;
wherein the step of analyzing the data includes the step of processing the received data from the validated message packet responsive to the validation; and
wherein the step of determining an optimal transmission power level setting includes at least one of the following steps:
determining a transmission power level setting of the adjacent node that improves a message packet validation rate of inbound message packets transmitted along the path between the at least one of the plurality of nodes and the adjacent node, and
determining a reduced meter data collector transmission power level setting of the adjacent node that maintains or improves the message packet validation rate of inbound message packets transmitted along the path between the at least one of the plurality of nodes and the adjacent node.

23. A method as defined in claim 21, further comprising the steps of determining a received signal strength indication data value at each of a source node and the destination node and determining a first and a second received signal strength indication at each of a plurality of intermediate nodes identified in the message packet along the first and the second preselected routes.

24. A method of collecting utility meter usage data, the method comprising the steps of:
determining a first sequence route from a source node to a destination node through at least one gateway node and a second sequence route from the destination node to the source node;
assigning a transmission power level setting separately to each of the nodes along the first and the second sequence routes;
transmitting a message packet carrying the power level settings to the destination node along the first sequence route; and
determining a received signal strength between each adjacent one of the nodes along at least a portion of at least one of the first and the second sequence routes, the received signal strength indicating that of the received message packet.

25. A method as defined in claim 24, wherein the transmission power level setting for each of the nodes is a respective first transmission power level setting for each node, wherein the message packet is a first message packet, wherein the received signal strength between each adjacent node is a respective first received signal strength between each adjacent node, and wherein the method further comprises the steps of:
receiving and validating the first message packet transmitted along the second sequence route to the source node;
selecting a respective second transmission power level setting for one of the nodes defining a common node;
transmitting a second message packet to a destination node along a third sequence route;
receiving and validating the second message packet transmitted along a fourth sequence route to the source node, the third or fourth sequence routes including the common node and an adjacent node adjacent the common node;
determining a respective second received signal strength at the adjacent node, the second received signal strength indicating a received signal strength associated with the second message packet transmitted between the common node and the adjacent node;
comparing the second received signal strength with the associated first received signal strength for the adjacent node responsive to receiving and validating the first and the second message packets; and
assigning the second power level setting to the at least one of the nodes responsive to the comparison according to at least one of the following sets of criteria:
the second transmission power level setting for the common node improves a message packet validation rate of message packets transmitted along the path between the common node and the adjacent node,
the second transmission power level setting for the common node results in substantially maintaining the message packet validation rate transmitted along the path between the common node and the adjacent node and the second transmission power level setting for the common node is less than the first transmission power level setting for the common node, and
the respective second received signal strength for the adjacent node is greater than the respective first received signal strength for the adjacent node and the second transmission power level setting for the common node is less than the first transmission power level setting for the common node.

26. A method as defined in claim 24, wherein the transmission power level setting for each of the nodes is a respective first transmission power level setting for each node, wherein the message packet is a first message packet, wherein the received signal strength between each adjacent node is a respective first received signal strength between each adjacent node, and wherein the method further comprises the steps of:
receiving and validating the first message packet transmitted along the second sequence route to the source node;
transmitting a second message packet to a destination node along a third sequence route;
receiving and validating the second message packet transmitted along a fourth sequence route to the source node;
determining a respective second received signal strength between each adjacent one of the nodes along the third sequence route and the fourth sequence route indicating received signal strengths associated with the received second message packet;
comparing the second received signal strengths with the first received signal strengths responsive to receiving and validating the first and the second message packets; and
determining a preferred polling sequence route responsive to the comparison.

27. A method as defined in claim 24, wherein the transmission power level settings provided in the message packet are unique for each of the nodes.

28. A method as defined in claim 24,
wherein the second sequence route is a reverse of the first sequence route;
wherein the step of determining a received signal strength between each adjacent node includes the step of determining a respective received signal strength indication data value at each of the at least one gateway nodes and at the destination node;
wherein the received signal strength indication data value at each of the at least one gateway nodes and at the destination node are respective first received signal strength indication data values; and
wherein the method further includes the step of determining a second received signal strength indication data value at each of the at least one gateway nodes and a first received signal strength indication data value at the source node.

29. A method as defined in claim 24,
wherein the second sequence route is a single segment between the destination node and the source node without intermediate gateway nodes defining a destination node-to-source node segment; and
wherein the step of determining a first sequence route from a source node to a destination node through at least one gateway node and a second sequence route from the destination node to the source node includes the step of selecting the first and the second sequence routes so that a plurality of node-to-node segments along two separate paths to the destination node from the source node can be polled in a single refresh segments message packet transmission to thereby reduce network congestion due to separate segment polling.

30. A method of collecting utility meter usage data, the method comprising the steps of:
determining a first sequence route from a source node to a destination node through at least one gateway node and a second sequence route from the destination node to the source node;
assigning a transmission power level setting separately to each of the nodes along the first and the second sequence routes;
transmitting at least one message packet carrying the power level settings along the first sequence route;
determining a first message packet data return rate;
determining a third sequence route having at least one common segment with the first sequence route or the second sequence route;
varying a transmit power level setting of at least one of the nodes associated with the common segment;
transmitting a second message packet carrying the varied power level setting along the third sequence route;
determining a second message packet data return rate;
comparing the first message packet data return rate to the second message packet data return rate; and
selecting the second power level setting for the at least one of the nodes responsive to the comparison when the second message packet data return rate is greater than the first message packet data return rate.

31. A method of collecting utility meter usage data, the method comprising the steps of:
determining a sequence route from a source node to a destination node through at least one gateway node;
assigning a transmission power level setting separately to each of the nodes; and
transmitting a message packet carrying the power level settings to the destination node along the sequence route.

32. A method as defined in claim 31, wherein the sequence route is a first sequence route, and wherein the method further comprises the steps of:
determining a second sequence route from the destination node to the source node;
receiving the message packet transmitted along the second sequence route to the source node; and
determining a received signal strength at least one of the nodes along the first or the second sequence route indicating a received signal strength associated with the received message packet when received.

33. A method as defined in claim 32, wherein the second sequence route is a reverse of the first sequence route.

34. A method of collecting utility meter usage data, the method comprising the steps of:
determining a sequence route from a source node to a destination node through at least one gateway node and from the destination node to the source node along an alternate pathway;
transmitting a message packet to the destination node along the sequence route;
receiving the message packet transmitted along the sequence route; and
determining a received signal strength at least one of the nodes along the sequence route indicating a signal strength associated with the received message packet when received.

35. A method as defined in claim 34, further comprising the step of assigning a new transmission power level setting to at least one of the nodes along the sequence route responsive to the received signal strength determination.

36. A method of collecting utility meter usage data, the method comprising the steps of:
determining a sequence route from a host computer to a destination meter data collector through at least one intermediate meter data collector;
transmitting a message packet to the destination meter data collector along the sequence route, the message packet having a payload data element including a meter data collector firmware update; and
receiving and storing the firmware update in memory of the destination meter data collector to thereby provide remote firmware management.

37. A method as defined in claim 36, further comprising the steps of receiving and storing the firmware update in memory of each intermediate meter data collector prior to forwarding the message packet to the destination meter data collector.

38. A method as defined in claim 36, further comprising the steps of:
determining a plurality of separate sequence routes from the host computer to a corresponding plurality of destination meter data collectors;
transmitting the firmware update to the plurality of destination meter data collectors; and
delaying implementing the firmware update to allow a synchronized update of the firmware for each of the plurality of destination meter data collectors.

39. A method as defined in claim 36, wherein the payload data element further includes meter data collector memory management parameters, and wherein the method further comprises the steps of:
receiving the memory management parameters; and
transferring data between the volatile and nonvolatile memory elements of the destination meter data collector responsive to the memory management parameters.

40. A method of collecting utility meter usage data, the method comprising the steps of:
determining a sequence route from a host computer to a destination meter data collector through at least one intermediate meter data collector;
transmitting a message packet to the destination meter data collector along the sequence route, the message packet having a payload data element including meter data collector memory management parameters; and
transferring data between the volatile and nonvolatile memory elements of the destination meter data collector responsive to the memory management parameters.

41. A method of collecting utility meter usage data, the method comprising the steps of:
determining a sequence route from a host computer to a destination meter data collector through at least one intermediate meter data collector;
providing a message packet having a payload data element;
loading a history and usage pointer in the payload data element, the history and usage pointer providing indicia of a starting point in memory of the destination meter data collector of unread history and usage data to thereby prevent history and usage data loss resulting from post transmission message packet loss or corruption of a message packet carrying history and usage data, the history and usage data loss resulting in a mismatch between the last history and usage data received by the host computer and the last history and usage data transmitted by the destination meter data collector; and
transmitting the message packet to the destination meter data collector along the sequence route.

42. A method as defined in claim 41, further comprising the steps of:
receiving the message packet by the destination meter data collector;
accessing the history and usage pointer provided in the payload data element;
reading a block of history and usage data from the memory of the meter data collector responsive to the history and usage pointer; and
transmitting the read history and usage data to the host computer.

43. A method as defined in claim 42, wherein the step of transmitting the read history and usage data to the host computer further includes the steps of:
loading the read history and usage data in the payload data element for transmission to the host computer; and
loading in the payload data element for transmission to the host computer indicia of a next read-memory location indicating the next position in the memory of the destination meter data collector to retrieve history and usage data.

44. A method as defined in claim 42,
wherein the step of loading a history and usage pointer in the payload data element includes the steps of accessing a database to determine the next-read memory location for the selected meter data collector and loading the next-read memory location into the payload data element of the message packet; and
wherein the method further comprises the steps of receiving the read history and usage data and next-read memory location indicia and storing the history and usage data and next-read memory location indicia in the database.

45. Meter data collector program product for enhancing communication between meter data collectors forming a mesh network, the program product comprising:
a protocol message packet generator adapted to assemble a protocol message packet including routing instructions between a plurality of meter data collectors, power level settings assignments for the meter data collectors, and receive signal strength indication placeholders to receive from each of the meter data collectors signal strength indications indicating the received signal strength of the protocol message packet;
a protocol message packet validator adapted to perform a validation analysis on a routed version of the protocol message packet to determine if the protocol message packet contains corrupted data;
a received signal strength indication determiner adapted to extract the receive signal strength indication from the protocol message packet responsive to protocol message packet validation; and
a power level settings determiner adapted to determine a substantially optimum power level setting for each of the meter data collectors responsive to the extracted received signal strength indications to thereby enhance individual mesh network segment strength and improve overall network performance.

46. Meter data collector program product as defined in claim 45, further comprising a memory manager adapted to provide instructions in the protocol message packet including those to perform the operation of filling characters in a range of memory addresses, writing data included in the protocol message packet from the protocol message packet to volatile and nonvolatile memory, reading data from volatile and nonvolatile memory and loading the data in the protocol message packet, and transferring data between various memory elements of the meter data collector.

47. Meter data collector program product as defined in claim 45, further comprising a history data integrity manager is adapted to provide instructions to perform the operations of accessing a database to determine a next-read memory location for a selected meter data collector, loading the next-read memory location into the protocol message packet, and storing an indication of the next-read memory location of received utility usage data of the selected destination meter data collector in the database responsive to return and validation of the protocol message packet having appended utility usage data.

48. A computer readable medium that is readable by a computer collecting utility usage data, the computer readable medium comprising a set of instructions that, when executed by the computer, cause the computer to perform the following operations:
assembling a message packet to transmit data to a selected one of a plurality of nodes defining a destination node according to a first preselected route to the destination node along at least one other of the plurality of nodes;
receiving and analyzing data in the message packet transmitted according to a second preselected route from the destination node; and
determining an optimal transmission power level setting of at least one of the plurality of nodes responsive to the data analysis.

49. A computer readable medium as defined in claim 48, further comprising a set of instructions that, when executed by a remote controller, cause the controller to perform the following operations:
determining a received signal strength indication describing the received signal strength of a transmission between adjacent nodes along the first or the second preselected routes for at least one pair of adjacent nodes of the plurality of nodes; and
uploading the received signal strength indication to the message packet.

50. A computer readable medium as defined in claim 48, wherein the instructions that, when executed by the computer, cause the computer to receive and analyze the data and the message packet, further cause the computer to perform the following operations:
validating the data in the message packet; and
processing the received data from the validated message packet responsive to the validation.

51. A computer readable medium as defined in claim 48, wherein the instructions that, when executed by the computer, cause the computer determine an optimal transmission power level setting, further cause the computer to perform at least one of the following operations:
determining a transmission power level setting of one of the plurality of nodes that improves a message packet validation rate of inbound message packets transmitted along a path between the one of the plurality of nodes and an adjacent node; and
determining a reduced meter data collector transmission power level setting of the one of the plurality of nodes that maintains or improves the message packet validation rate of inbound message packets transmitted along the path between the one of the plurality of nodes and the adjacent node.

52. A computer readable medium that is readable by a computer collecting utility usage data, the computer readable medium comprising a set of instructions that, when executed by the computer, cause the computer to perform the following operations:
determining a first sequence route from a source node to a destination node through at least one gateway node and a second sequence route from the destination node to the source node;
assigning a transmission power level setting separately to each of the nodes along the first and the second sequence routes;
sending a message packet carrying the power level settings to the destination node along the first sequence route;
receiving and validating the first message packet transmitted along the second sequence route; and
determining a received signal strength between each adjacent one of the nodes along at least a portion of at least one of the first and the second sequence routes, the received signal strengths indicating that of the received message packet.

53. A computer readable medium as defined in claim 52, wherein the transmission power level setting for each of the nodes is a respective first transmission power level setting for each node, wherein the message packet is a first message packet, wherein the received signal strength between each adjacent node is a respective first received signal strength between each adjacent node, the computer readable medium further comprising a set of instructions that, when executed by the computer, cause the computer to perform the following operations:
selecting a respective second transmission power level setting for one of the nodes defining a common node;
sending a second message packet to a destination node along a third sequence route;
receiving and validating the second message packet transmitted along a fourth sequence route, the third or fourth sequence routes including the common node and an adjacent node adjacent the common node;
determining a respective second received signal strength at the adjacent node, the second received signal strength indicating a received signal strength associated with the second message packet transmitted between the common node and the adjacent node;
comparing the second received signal strength with the associated first received signal strength for the adjacent node responsive to receiving and validating the first and the second message packets; and
assigning the second power level setting to the at least one of the nodes responsive to the comparison.

54. A computer readable medium as defined in claim 52, wherein the operation of assigning the second power level setting to the at least one of the nodes responsive to the comparison according to at least one of the following sets of criteria:
the second transmission power level setting for the common node improves a message packet validation rate of message packets transmitted along the path between the common node and the adjacent node;
the second transmission power level setting for the common node results in substantially maintaining the message packet validation rate transmitted along the path between the common node and the adjacent node and the second transmission power level setting for the common node is less than the first transmission power level setting for the common node; and
the respective second received signal strength for the adjacent node is greater than or substantially equal to the respective first received signal strength for the adjacent node and the second transmission power level setting for the common node is less than the first transmission power level setting for the common node.

55. A computer readable medium as defined in claim 52, wherein the transmission power level setting for each of the nodes is a respective first transmission power level setting for each node, wherein the message packet is a first message packet, wherein the received signal strength between each adjacent node is a respective first received signal strength between each adjacent node, the computer readable medium further comprising a set of instructions that, when executed by the computer, cause the computer to perform the following operations:
receiving and validating the first message packet transmitted along the second sequence route;
sending a second message packet to a destination node along a third sequence route;
receiving and validating the second message packet transmitted along a fourth sequence route;
determining a respective second received signal strength between each adjacent one of the nodes along the third sequence route and the fourth sequence route indicating received signal strengths associated with the received second message packet;
comparing the second received signal strengths with the first received signal strengths responsive to receiving and validating the first and the second message packets; and
determining a preferred polling sequence route responsive to the comparison.

56. A computer readable medium as defined in claim 52, wherein the operation of determining a first sequence route from a source node to a destination node through at least one gateway node and a second sequence route from the destination node to the source node includes the step of selecting the first and the second sequence routes so that a plurality of node-to-node segments along two separate paths to the destination node from the source node can be polled in a single refresh segments message packet transmission to thereby reduce network congestion due to separate segment polling.

57. A computer readable medium that is readable by a computer collecting utility usage data, the computer readable medium comprising a set of instructions that, when executed by the computer, cause the computer to perform the following operations:
determining a first sequence route from a source node to a destination node through at least one gateway node and a second sequence route from the destination node to the source node;
assigning a first transmission power level setting separately to each of the nodes along the first and the second sequence routes;
sending at least one message packet carrying the power level settings along the first sequence route;
determining a first message packet data return rate;
determining a third sequence route having at least one common segment with the first sequence route or the second sequence route;
varying a transmit power level setting of at least one of the nodes associated with the common segment to define a second power level setting;
sending a second message packet carrying the varied power level setting along the third sequence route;
determining a second message packet data return rate;
comparing the first message packet data return rate to the second message packet data return rate; and
selecting the second power level setting for the at least one of the nodes responsive to the comparison when the second message packet data return rate is greater than the first message packet data return rate and when the second message packet data return rate is not substantially less than the first message packet data return rate and the second power level setting is less than the first power level setting.

58. A computer readable medium that is readable by a computer collecting utility usage data, the computer readable medium comprising a set of instructions that, when executed by the computer, cause the computer to perform the following operations:
determining a sequence route from a source node to a destination node through at least one gateway node;
assigning a transmission power level setting separately to each of the nodes; and
sending a message packet carrying the power level settings along the sequence route.

59. A computer readable medium as defined in claim 58, further comprising a set of instructions that, when executed by the computer, cause the computer to perform the following operations:
determining a second sequence route from the destination node to the source node;
receiving the message packet transmitted along the second sequence route to the source node;
determining a received signal strength indication at least one of the nodes along the first or the second sequence route indicating a received signal strength associated with the received message packet when received; and
changing the assigned power level setting for at least one of the nodes responsive to the respective received signal strength indication determination for the at least one of the nodes.

60. A computer readable medium that is readable by a computer collecting utility usage data and a remote controller of a meter data collector, the computer readable medium comprising:
a first set of instructions that when executed by the computer cause the computer to perform the operations of determining a sequence route from a host computer system to a destination meter data collector through at least one intermediate meter data collector, and sending a message packet to the destination meter data collector along the sequence route, the message packet having a payload data element including a meter data collector firmware update; and
a second set of instructions that when executed by the remote controller cause the computer to perform the operation of receiving and storing the firmware update in memory of the destination meter data collector to thereby provide remote firmware management.

61. A computer readable medium as defined in claim 60, wherein the at least one meter data collector is a plurality of meter data collectors each having a remote controller and associated memory, the computer readable medium further comprising instructions that, when executed by the remote controller of each of the plurality of intermediate meter data collectors, cause the associated controller to perform the operations of receiving and storing the firmware update in the memory of each respective intermediate meter data collector prior to forwarding the message packet along the sequence route to the destination meter data collector.

62. A computer readable medium as defined in claim 60, further comprising a set of instructions that, when executed by the computer, cause the computer to perform the following operations:
determining a plurality of separate sequence routes from the host computer system to a corresponding plurality of destination meter data collectors;
sending the firmware update to the plurality of destination meter data collectors; and
delaying implementing the firmware update to allow a synchronized update of the firmware for each of the plurality of destination meter data collectors.

63. A computer readable medium that is readable by a computer collecting utility usage data and a controller of a destination meter data collector, the computer readable medium comprising:
a first set of instructions that when executed by the computer cause the computer to perform the operation of determining a sequence route from a host computer system to a destination meter data collector, and sending a message packet to the destination meter data collector along the sequence route, the message packet having a payload data element including meter data collector memory management parameters; and
a second set of instructions that when executed by the controller cause the controller to perform the operation of receiving the memory management parameters, and transferring data between the volatile and nonvolatile memory elements of the destination meter data collector responsive to the memory management parameters.

64. A computer readable medium that is readable by a computer collecting utility usage data, the computer readable medium comprising a set of instructions that, when executed by the computer, cause the computer to perform the following operations:
determining a sequence route from a host computer system to a destination meter data collector;
providing a message packet having a payload data element;
loading a history and usage pointer in the payload data element, the history and usage pointer providing indicia of a starting point in memory of the destination meter data collector of unread history and usage data; and
sending the message packet to the destination meter data collector along the sequence route.

65. A computer readable medium as defined in claim 64, further comprising a set of instructions that, when executed by a controller of a destination meter data collector, cause the controller to perform the following operations:
receiving the message packet;
accessing the history and usage pointer provided in the payload data element;
reading a block of history and usage data from memory of the meter data collector responsive to the history and usage pointer; and
sending the read history and usage data to the host computer system.

66. A computer readable medium as defined in claim 65, wherein the instructions that, when executed by the controller of the destination meter data collector cause the controller to send the read history and usage data to the host computer system, further cause the controller to perform the following operations:
loading the read history and usage data in the payload data element for sending to the host computer system; and
loading indicia of a next read-memory location in the payload data element for sending to the host computer system, the indicia of a next read-memory location indicating the next position in the memory of the destination meter data collector to retrieve history and usage data.

67. A computer readable medium as defined in claim 66,
wherein the instructions that when executed by the controller cause the controller to load a history and usage pointer in the payload data element, further cause the controller to perform the operations of accessing a database to determine the next-read memory location for the selected meter data collector, and loading the next-read memory location into the payload data element of the message packet; and
wherein the computer readable medium further comprises a set of instructions that, when executed by the computer, cause the computer to perform the operations of receiving the read history and usage data and next-read memory location indicia and storing the history and usage data and next-read memory location indicia in the database.

68. A computer memory element containing, stored in signal bearing media, a database, the database containing the following data in computer readable format:
data indicating utility service history and usage provided by each of a plurality of meter data collectors; and
data indicating a starting point in memory of the next block of unread history and usage data defining a next-read memory location for each of the plurality of meter data collectors.

69. A computer memory element as defined in claim 68 further containing in computer readable format data indicating a preselected power level setting for each of the plurality of meter data collectors.
